(19) United States
(12) Patent Application Publication
(10) Pub. No.: US 2020/0220266 A1
(43) Pub. Date: Jul. 9, 2020

(54) ANTENNA ELEMENT AND METHOD FOR MANUFACTURING ANTENNA ELEMENT

(71) Applicant: Murata Manufacturing Co., Ltd., Nagaokakyo-shi (JP)

(72) Inventors: Atsushi ISAYAMA, Nagaokakyo-shi (JP); Masamichi TAMURA, Nagaokakyo-shi (JP); Daigo MATSUBARA, Nagaokakyo-shi (JP); Nobuyuki TENNO, Nagaokakyo-shi (JP)

(21) Appl. No.: 16/819,271

(22) Filed: Mar. 16, 2020

Related U.S. Application Data
(63) Continuation of application No. PCT/JP2019/020199, filed on May 22, 2019.

(30) Foreign Application Priority Data
May 31, 2018 (JP) 2018-105324

(51) Int. Cl. H01Q 7/06; H01Q 1/12

(52) U.S. Cl. CPC H01Q 7/06; H01Q 1/12

(57) ABSTRACT

An antenna element includes a multilayer body and a coil conductor. The multilayer body includes a first non-magnetic portion and a first magnetic portion laminated together. The first magnetic portion is closer to a first principal surface than is the first non-magnetic portion. The coil conductor includes a first conductor pattern portion and a first insulating pattern portion. The first conductor pattern portion is disposed between the first non-magnetic portion and the first magnetic portion. The first insulating pattern portion is provided on the first conductor pattern portion at a side facing the second principal surface, and has a line width less than a line width of the first conductor pattern portion. The first insulating pattern portion overlaps the first conductor pattern portion in plan view as viewed in a lamination direction of the multilayer body.

### CROSS REFERENCE TO RELATED APPLICATIONS

This application claims the benefit of priority to Japanese Patent Application No. 2018-105324 filed on May 31, 2018 and is a Continuation Application of PCT Application No. PCT/JP2019/020199 filed on May 22, 2019. The entire contents of each application are hereby incorporated herein by reference.

### BACKGROUND OF THE INVENTION

### 1. Field of the Invention

The present invention relates to antenna elements and methods for manufacturing antenna elements, and more particularly, to an antenna element including a coil conductor disposed in a multilayer body including a non-magnetic portion and a magnetic portion and a method for manufacturing the antenna element.

### 2. Description of the Related Art

Antenna devices (antenna elements) including an antenna coil (coil conductor) have been known (see, for example, International Publication No. WO 2015/008704).

An antenna device described in International Publication No. WO 2015/008704 is configured such that a plurality of magnetic material layers (magnetic layers) are laminated and an antenna coil includes a plurality of wiring patterns (conductor pattern portions) formed on surfaces of the magnetic material layers. The antenna coil described in International Publication No. WO 2015/008704 is formed in the magnetic material layers and has a coil winding axis extending in a lamination direction in which the magnetic material layers are laminated.

The known antenna elements, such as the antenna device described in International Publication No. WO 2015/008704, are disadvantageous in that the magnetic loss increases when the coil conductor is covered with the magnetic portion. Such a disadvantage may be overcome by, for example, not covering the coil conductor with the magnetic portion and placing the coil conductor at a position separated from the magnetic portion. However, when the coil conductor is separated from the magnetic portion, it becomes difficult to achieve efficient magnetic flux radiation and the communication performance of the antenna element is degraded.

### SUMMARY OF THE INVENTION

Preferred embodiments of the present invention provide antenna elements in each of which magnetic loss is reduced and communication performance of the antenna elements is improved, and also provide methods for manufacturing the antenna elements.

An antenna element according to a preferred embodiment of the present invention includes a multilayer body and a coil conductor. The multilayer body includes a first non-magnetic portion and a first magnetic portion. The first magnetic portion is laminated on the first non-magnetic portion. The coil conductor is provided in the multilayer body. The coil conductor has a winding axis that is parallel or substantially parallel to a lamination direction of the multilayer body. The multilayer body includes a first principal surface and a second principal surface. The second principal surface is opposite to the first principal surface in the lamination direction, and defines and functions as a mounting surface. The first magnetic portion is closer to the first principal surface than is the first non-magnetic portion in the lamination direction. The coil conductor includes a first conductor pattern portion and a first insulating portion. The first conductor pattern portion is disposed between the first non-magnetic portion and the first magnetic portion in the lamination direction. The first insulating portion is provided on the first conductor pattern portion at a side facing the second principal surface, and has a width less than a line width of the first conductor pattern portion. The first insulating portion overlaps the first conductor pattern portion in plan view as viewed in the lamination direction.

A method for manufacturing an antenna element according to a preferred embodiment of the present invention includes a step of preparing a non-magnetic layer that forms a non-magnetic portion and a magnetic layer that forms a magnetic portion. The method for manufacturing an antenna element further includes a step of providing a first conductor pattern portion on a principal surface of the magnetic layer. The method for manufacturing an antenna element further includes a step of providing an auxiliary film on the first conductor pattern portion, the auxiliary film having a width less than a line width of the first conductor pattern portion. The method for manufacturing an antenna element further includes a step of stacking the non-magnetic layer on the magnetic layer so as to cover the principal surface on which the first conductor pattern portion and the auxiliary film are provided. The method for manufacturing an antenna element further includes a step of pressing the magnetic layer and the non-magnetic layer in a stacked state in a lamination direction so that a portion of the first conductor pattern portion on which the auxiliary film is provided is positioned farther toward the magnetic layer than is a remaining portion of the first conductor pattern portion. The method for manufacturing an antenna element further includes a step of sintering a multilayer body to form a first insulating portion having a width less than the line width of the first conductor pattern portion.

According to antenna elements of preferred embodiments of the present invention, the magnetic loss is reduced and the communication performance of the antenna elements is improved.

According to methods for manufacturing antenna elements of preferred embodiments of the present invention, antenna elements in each of which the magnetic loss is reduced and the communication performance of the antenna elements is improved are able to be manufactured.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a sectional view of an antenna element according to a first preferred embodiment of the present invention.

FIG. 1B is an enlarged view of a main portion of the antenna element.

FIG. 2 is a perspective view of the antenna element.

FIG. 3 is a front view of the antenna element.

FIG. 4A is a schematic diagram illustrating magnetic flux in the antenna element. FIG. 4B is a schematic diagram illustrating magnetic flux in an antenna element according to a comparative example.

FIG. 5 shows plan views of some of a plurality of base material layers of the antenna element.

FIG. 6 shows plan views of the remaining base material layers of the antenna element.

FIG. 7A is a sectional view of an antenna element according to a second preferred embodiment of the present invention.

FIG. 7B is an enlarged view of a main portion of the antenna element.

FIG. 8 is a sectional view of an antenna element according to a third preferred embodiment of the present invention.

FIG. 9 is a sectional view of an antenna element according to a fourth preferred embodiment of the present invention.

FIG. 10 is a sectional view of an antenna element according to a fifth preferred embodiment of the present invention.

FIG. 11 shows plan views of some of a plurality of base material layers of the antenna element.

FIG. 12 shows plan views of the remaining the base material layers of the antenna element.

### DETAILED DESCRIPTION OF THE PREFERRED EMBODIMENTS

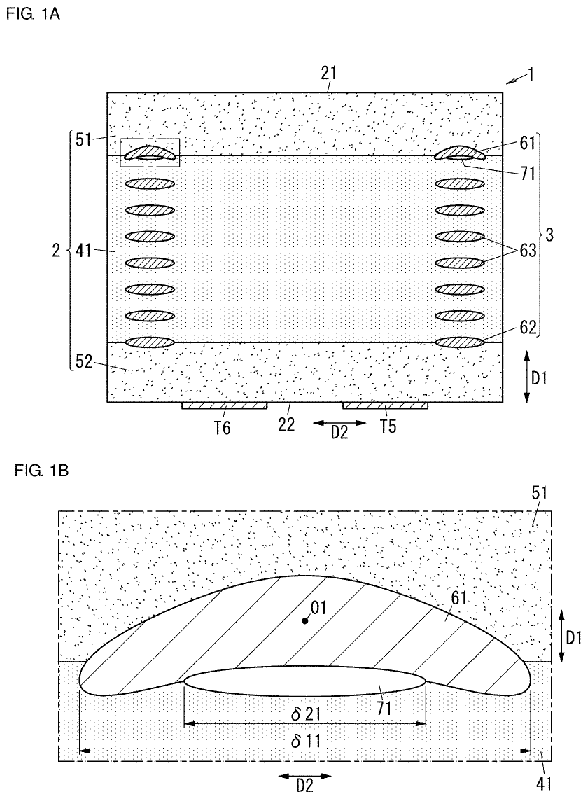

Antenna elements and methods for manufacturing antenna elements according to first to fifth preferred embodiments of the present invention will now be described with reference to the drawings. In the following description including the description of the preferred embodiments, differences from previously described preferred embodiments will be mainly described. In particular, description of similar advantageous effects obtained by similar structures will not be repeated in all preferred embodiments, and will be partially or entirely omitted. The drawings referred to in the following description including the description of the preferred embodiments are schematic, and ratios between the sizes and thicknesses of components in the drawings do not necessarily reflect the actual dimensional ratios. Although FIGS. 1A, 1B, 7A, 7B, and 8 to 10 are all sectional views, portions of the structures are shown with dotted patterns to facilitate understanding of the structures. FIG. 1A is a sectional view taken along line X-X in FIG. 3.

An “antenna element” according to each preferred embodiment of the present invention is an antenna element included in a “wireless communication system”. The “wireless communication system” is a system that performs wireless communication with a communication partner (antenna of an external device) by magnetic field coupling. The term “communication” includes not only transmission and reception of signals but also transmission and reception of electric power. The term “wireless communication system” includes both a short-distance wireless communication system and a wireless power supply system. The antenna element is used for wireless communication by magnetic field coupling, and therefore the length of the current path of the antenna element, that is, the line length of the coil conductor described below, is sufficiently shorter than a wave length λ at a frequency used for the wireless communication, and is preferably about λ/10 or less, for example. Accordingly, the electromagnetic wave radiation efficiency is low in a frequency band used for the wireless communication. The wave length λ referred to herein is an effective wave length determined in consideration of the wave length shortening effect due to the dielectric properties and magnetic permeability of a base material on which the coil conductor is provided. Both ends of the coil conductor are connected to a power supply circuit, and a constant or substantially constant current flows through the current path of the antenna, that is, the coil conductor.

The short-distance wireless communication for which the “antenna element” according to each preferred embodiment of the present invention is preferably used is, for example, near field communication (NFC). The frequency band used for the short-distance wireless communication is preferably, for example, an HF band, in particular, a frequency band at and around 13.56 MHz.

A wireless power supply method for the “antenna element” according to each preferred embodiment may preferably be, for example, a magnetic field coupling method, such as an electromagnetic induction method or a magnetic field resonance method. An example of a wireless power supply standard for the electromagnetic induction method is the “Qi (registered trademark)” standard established by the Wireless Power Consortium (WPC). The frequency band used for the electromagnetic induction method is included in, for example, a frequency band in the range from about 110 kHz to about 205 kHz or near this range. An example of a wireless power supply standard for the magnetic field resonance method is the “AirFuel Resonant” standard established by the AirFuel (registered trademark) Alliance. The frequency band used for the magnetic field resonance method is, for example, the 6.78 MHz band or the 100 kHz band.

### First Preferred Embodiment

### (1) Overview of First Preferred Embodiment

An overview of a first preferred embodiment of the present invention will be described with reference to FIGS. 1A and 1B.

An antenna element 1 according to the first preferred embodiment includes a multilayer body 2 and a coil conductor 3. The multilayer body 2 of the antenna element 1 includes a first non-magnetic portion 41 and a first magnetic portion 51 laminated on the first non-magnetic portion 41. The coil conductor 3 is provided in the multilayer body 2, and has a winding axis parallel or substantially parallel to a lamination direction D1 of the multilayer body 2. In this specification, the term “parallel” does not necessarily mean exactly “parallel”, and includes a case where an angle with respect to a certain direction is about 0° to ±about 15°. In other words, a substantially parallel relationship is included. The winding axis of the coil conductor 3, for example, may be at an angle of about 0° to ±about 15° with respect to the lamination direction D1.

The multilayer body 2 includes a first principal surface 21 and a second principal surface 22. The second principal surface 22 is opposite to the first principal surface 21 in the lamination direction D1, and defines and functions as a mounting surface. The first magnetic portion 51 is closer to the first principal surface 21 than is the first non-magnetic portion 41 in the lamination direction D1.

The coil conductor 3 of the above-described antenna element 1 includes a first conductor pattern portion 61 and a first insulating pattern portion 71. The first conductor pattern portion 61 is disposed between the first non-magnetic portion 41 and the first magnetic portion 51 in the lamination direction D1. The first insulating pattern portion 71 is provided on the first conductor pattern portion 61 at a side facing the second principal surface 22, and has a line width 821 less than a line width 811 of the first conductor pattern portion 61. The first insulating pattern portion 71 overlaps the first conductor pattern portion 61 in plan view as viewed in the lamination direction D1.

In this specification, the expression “conductor pattern portion is disposed between the non-magnetic portion and the magnetic portion in the lamination direction D1” means that the conductor pattern portion is in contact with both the non-magnetic portion and the magnetic portion in the lamination direction D1.

As described above, the antenna element 1 is configured such that the first conductor pattern portion 61 of the coil conductor 3 is provided between the first magnetic portion 51 and the first non-magnetic portion 41. Accordingly, the magnetic loss is less than that when the coil conductor 3 is covered with a magnetic portion.

In addition, the antenna element 1 is configured such that the first conductor pattern portion 61 disposed between the first non-magnetic portion 41 and the first magnetic portion 51 includes the first insulating pattern portion 71 provided on the first conductor pattern portion 61 at a side facing the second principal surface 22, the first insulating pattern portion 71 having the line width 821 less than the line width 811 of the first conductor pattern portion 61. Accordingly, the first conductor pattern portion 61 can be shaped to bulge toward the first principal surface 21 as a result of, for example, a pressing step, so that the direction of magnetic flux can be brought closer to the lamination direction D1 than to a direction D2 orthogonal or substantially orthogonal to the lamination direction D1. In particular, a side surface of the first conductor pattern portion 61 facing the first principal surface 21 protrudes by a greater amount than does a side surface of the first conductor pattern portion 61 facing the second principal surface 22. Therefore, the direction of the magnetic flux can be easily brought closer to the lamination direction D1. As a result, the communication performance of the antenna element 1 can be improved.

Thus, the magnetic loss can be reduced and the communication performance of the antenna element 1 can be improved.

### (2) Details of First Preferred Embodiment

Details of the first preferred embodiment will now be described.

### (2.1) Overall Structure of Antenna Element

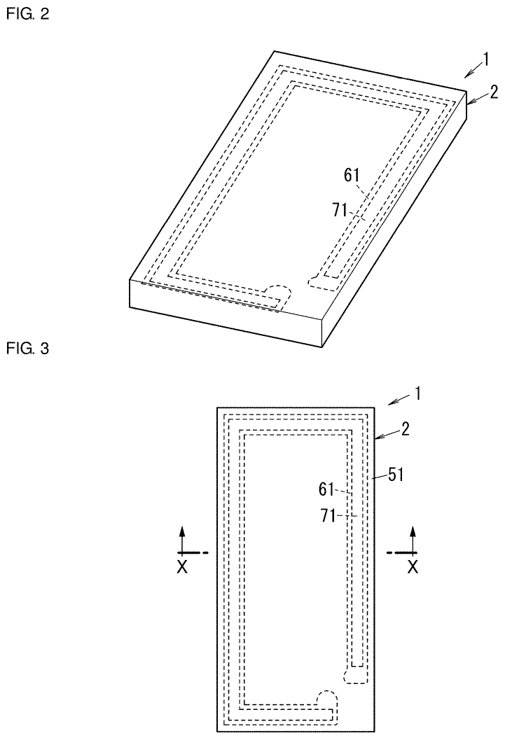

As illustrated in FIGS. 1A, 2, and 3, the antenna element according to the first preferred embodiment includes the multilayer body 2 and the coil conductor 3. As illustrated in FIG. 2, the antenna element 1 preferably has, for example, a rectangular or substantially rectangular parallelepiped-shape. With regard to the dimensions of the antenna element 1, the antenna element 1 preferably has, for example, a length of about 6 mm, a width of about 3 mm, and a height of about 1 mm. The dimensions of the antenna element 1 are not limited to this.

### (2.2) Components of Antenna Element

Components of the antenna element 1 according to the first preferred embodiment will now be described with reference to the drawings.

### (2.2.1) Multilayer Body

As illustrated in FIG. 1A, the multilayer body 2 includes the first non-magnetic portion 41 and the first magnetic portion 51 laminated on the first non-magnetic portion 41. The multilayer body 2 further includes a second magnetic portion 52.

The multilayer body 2 includes the first principal surface 21 and the second principal surface 22. The second principal surface 22 is opposite to the first principal surface 21 in the lamination direction D1 of the multilayer body 2, and defines and functions as a mounting surface.

### (2.2.2) First Non-Magnetic Portion

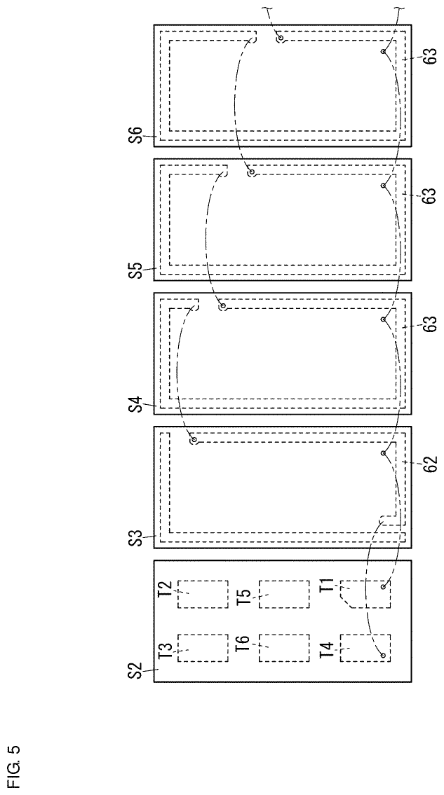

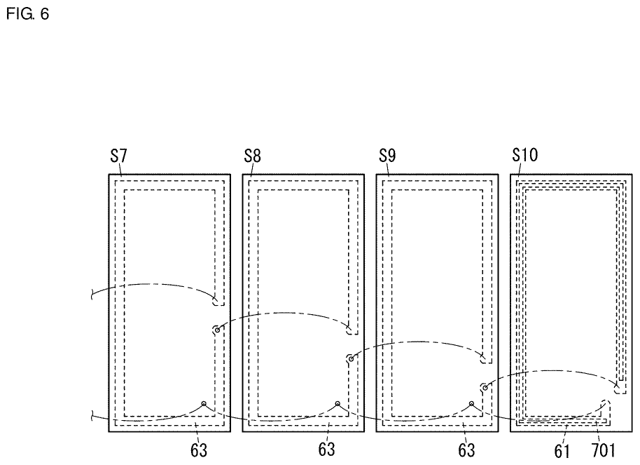

The first non-magnetic portion 41 includes a plurality of non-magnetic layers S3 to S9 (see FIGS. 5 and 6) that are laminated together. The first non-magnetic portion 41 is sandwiched between the first magnetic portion 51 and the second magnetic portion 52 in the lamination direction D1. The non-magnetic layers S3 to S9 of the first non-magnetic portion 41 are each preferably a sintered body of, for example, a non-magnetic ferrite of a low temperature co-fired ceramic (LTCC).

### (2.2.3) First Magnetic Portion

The first magnetic portion 51 is closer to the first principal surface 21 than is the first non-magnetic portion 41 in the lamination direction D1. More specifically, the first magnetic portion 51 is disposed on the first non-magnetic portion 41 at a side facing a radiation surface. The first magnetic portion 51 includes at least one magnetic layer including a magnetic layer S10 (see FIG. 6). The magnetic layer S10 of the first magnetic portion 51 is preferably a sintered body of, for example, a magnetic ferrite of a low temperature co-fired ceramic. The expression “first magnetic portion 51 is closer to the first principal surface 21 than is the first non-magnetic portion 41 in the lamination direction D1” includes both a case where a principal surface of the first magnetic portion 51 defines and functions as the first principal surface 21, as illustrated in FIG. 1A, and a case where the principal surface of the first magnetic portion 51 differs from the first principal surface 21.

### (2.2.4) Second Magnetic Portion

The second magnetic portion 52 is closer to the second principal surface 22 than is the first non-magnetic portion 41 in the lamination direction D1. More specifically, the second magnetic portion 52 is disposed on the first non-magnetic portion 41 at a side facing the mounting surface. The second magnetic portion 52 includes at least one magnetic layer including a magnetic layer S2 (see FIG. 5). The magnetic layer S2 of the second magnetic portion 52 is preferably a sintered body of, for example, a magnetic ferrite of a low temperature co-fired ceramic. The expression “second magnetic portion 52 is closer to the second principal surface 22 than is the first non-magnetic portion 41 in the lamination direction D1” includes both a case where a principal surface of the second magnetic portion 52 defines and functions as the second principal surface 22, as illustrated in FIG. 1A, and a case where the principal surface of the second magnetic portion 52 differs from the second principal surface 22.

### (2.2.5) Coil Conductor

As illustrated in FIG. 1A, the coil conductor 3 is provided in the multilayer body 2. The winding axis of the coil conductor 3 is parallel or substantially parallel to the lamination direction D1 of the multilayer body 2. More specifically, the coil conductor 3 is provided in the first non-magnetic portion 41, at the boundary between the first non-magnetic portion 41 and the first magnetic portion 51, or at the boundary between the first non-magnetic portion 41 and the second magnetic portion 52.

The coil conductor 3 includes the first conductor pattern portion 61, a second conductor pattern portion 62, a plurality of third conductor pattern portions 63 (six third conductor pattern portions 63 in the illustrated example), and the first insulating pattern portion 71.

### (2.2.6) First Conductor Pattern Portion

The first conductor pattern portion 61 is disposed between the first non-magnetic portion 41 and the first magnetic portion 51 in the lamination direction D1. More specifically, the first conductor pattern portion 61 is a portion of the coil conductor 3 that is closest to the first principal surface 21 (radiation surface), and is provided at the boundary between the first non-magnetic portion 41 and the first magnetic portion 51. The first conductor pattern portion 61 is preferably, for example, a conductor pattern portion including Ag as a main component.

### (2.2.7) Second Conductor Pattern Portion

The second conductor pattern portion 62 is disposed between the first non-magnetic portion 41 and the second magnetic portion 52 in the lamination direction D1. More specifically, the second conductor pattern portion 62 is a portion of the coil conductor 3 that is closest to the second principal surface 22 (mounting surface), and is provided at the boundary between the first non-magnetic portion 41 and the second magnetic portion 52. The second conductor pattern portion 62 is preferably, for example, a conductor pattern portion including Ag as a main component.

### (2.2.8) Third Conductor Pattern Portions

Each of the third conductor pattern portions 63 is disposed in the first non-magnetic portion 41. In other words, each third conductor pattern portion 63 is covered with the first non-magnetic portion 41. Each third conductor pattern portion 63 is preferably, for example, a conductor pattern portion including Ag as a main component.

One of the third conductor pattern portions 63 that is adjacent to the first conductor pattern portion 61 is electrically connected to the first conductor pattern portion 61 by an interlayer connection conductor. The interlayer connection conductor is provided in the first non-magnetic portion 41. More specifically, the interlayer connection conductor extends through the non-magnetic layer S9 (see FIG. 6), which is included in the first non-magnetic portion 41.

One of the third conductor pattern portions 63 that is adjacent to the second conductor pattern portion 62 is electrically connected to the second conductor pattern portion 62 by an interlayer connection conductor. The interlayer connection conductor is provided in the first non-magnetic portion 41. More specifically, the interlayer connection conductor extends through the non-magnetic layer S3 (see FIG. 5), which is included in the first non-magnetic portion 41.

### (2.2.9) First Insulating Pattern Portion

The first insulating pattern portion 71 is provided on the first conductor pattern portion 61 at a side facing the second principal surface 22, and has the line width 821 less than the line width 811 of the first conductor pattern portion 61. The first insulating pattern portion 71 overlaps the first conductor pattern portion 61 in plan view as viewed in the lamination direction D1. In other words, the first insulating pattern portion 71, which has the line width 821 less than the line width 811 of the first conductor pattern portion 61, extends along the first conductor pattern portion 61. The “insulating pattern portion” described in this specification corresponds to an “insulating portion”. The first insulating pattern portion 71 corresponds to a first insulating portion.

The line width 821 of the first insulating pattern portion 71 is less than the line width 811 of the first conductor pattern portion 61, and the thickness of the first insulating pattern portion 71 is less than the thickness of the first conductor pattern portion 61. The relationship between the dimensions of the first insulating pattern portion 71 and the first conductor pattern portion 61 is not limited by the above description.

Since the first insulating pattern portion 71 is provided on the first conductor pattern portion 61 at the side facing the second principal surface 22, the first conductor pattern portion 61 bulges toward the first principal surface 21 (radiation surface) as a result of manufacturing steps described below.

The first conductor pattern portion 61 is shaped as illustrated in FIG. 1B. Thus, the first conductor pattern portion 61 has a convex shape. In other words, a central portion of the first conductor pattern portion 61 protrudes farther toward the first magnetic portion 51 than do both end portions of the first conductor pattern portion 61. In other words, a centroid O1 of the first conductor pattern portion 61 is shifted toward the first magnetic portion 51 in the lamination direction D1. More specifically, the centroid O1 of the first conductor pattern portion 61 is closer to the first principal surface 21 than is the centroid of a flat first conductor pattern portion in the lamination direction D1. The first conductor pattern portion 61 does not necessarily have a sharply protruding shape, and may have a gently protruding shape.

The multilayer body including the first non-magnetic portion 41, the first magnetic portion 51, and the second magnetic portion 52 may be pressed in the lamination direction D1 after an auxiliary film 701 (see FIG. 6) is provided on the first conductor pattern portion 61 at a position where the first insulating pattern portion 71 is to be formed. In this case, as a result of being pressed in the lamination direction D1, the first conductor pattern portion 61 is shaped such that the central portion thereof protrudes farther toward the first principal surface 21 than do both end portions thereof. When the above-described multilayer body is sintered while being pressed in the lamination direction D1, the auxiliary film 701 is burned so that the first insulating pattern portion 71 is formed. The second conductor pattern portion and the third conductor pattern portions 63, which are not provided with an insulating pattern portion similar to the first insulating pattern portion 71, are not shaped similarly to the first conductor pattern portion 61, and have a flat or substantially flat shape.

The first insulating pattern portion 71 is a void. In other words, the first insulating pattern portion 71 is a void pattern portion having a void pattern.

### (2.3) Flow of Magnetic Flux

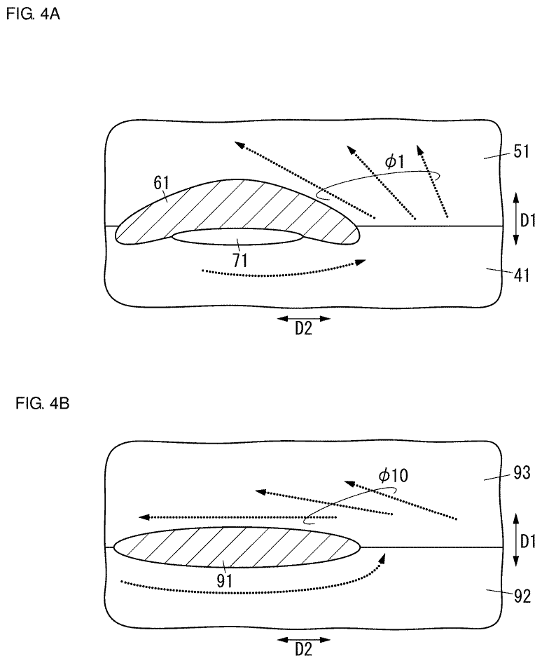

The flow of magnetic flux will now be described with reference to FIGS. 4A and 4B.

As illustrated in FIG. 4A, the first insulating pattern portion 71 having the line width 821 less than the line width 811 of the first conductor pattern portion 61 is provided on the first conductor pattern portion 61 at a side facing the second principal surface 22. Accordingly, as described above, the first conductor pattern portion 61 bulges toward the first principal surface 21.

Since the first conductor pattern portion 61 bulges toward the first principal surface 21, as shown by the arrows in FIG. 4A, the direction of magnetic flux ϕ1 in the first magnetic portion 51 can be brought closer to the lamination direction D1 from the direction D2 orthogonal or substantially orthogonal to the lamination direction D1. In other words, a component of the magnetic flux ϕ1 in the lamination direction D1 can be increased. As a result, the communication performance of the antenna element 1 is improved.

In contrast, in a comparative example in which the first insulating pattern portion 71 is not provided, as illustrated in FIG. 4B, a first conductor pattern portion 91 disposed between a first non-magnetic portion 92 and a first magnetic portion 93 does not have a bulging shape. The direction of magnetic flux ϕ10 in the first magnetic portion 93 is closer to the direction D2 orthogonal to the lamination direction D1 than that in the first preferred embodiment. Therefore, the component in the lamination direction D1 is small, and the communication performance of the antenna element cannot be easily improved.

More specifically, according to the antenna element 1 of the first preferred embodiment, the first conductor pattern portion 61 bulges toward the first principal surface 21, so that the communication performance of the antenna element 1 is higher than that in the comparative example in which the first conductor pattern portion 91 does not have a bulging shape.

### (2.4) Method for Manufacturing Antenna Element

A non-limiting example of a method for manufacturing the antenna element 1 according to the first preferred embodiment will now be described with reference to FIGS. 5 and 6. The antenna element 1 according to the first preferred embodiment is manufactured by first to seventh steps. Base material layers illustrated in FIGS. 5 and 6 are the non-magnetic layers S3 to S9 and the magnetic layers S2 and S10. The one-dot chain lines in FIGS. 5 and 6 show major connections provided by interlayer connection conductors. The non-magnetic layer S6 illustrated in FIG. 5 and the non-magnetic layer S7 illustrated in FIG. 6 are electrically connected to each other by interlayer connection conductors.

In the first step, the non-magnetic layers S3 to S9 that form the first non-magnetic portion 41, the magnetic layer S2 that forms the second magnetic portion 52, and the magnetic layer S10 that forms the first magnetic portion 51 are prepared. The non-magnetic layers S3 to S9 are each a sintered body of, for example, a non-magnetic ferrite of a low temperature co-fired ceramic (green sheet). The magnetic layers S2 and S10 are each a sintered body of, for example, a magnetic ferrite of a low temperature co-fired ceramic (green sheet).

In the second step, a plurality of terminal electrodes T1 to T6 are formed on a back surface of the magnetic layer S2. The terminal electrodes T1 to T6 are each, for example, a rectangular or substantially rectangular conductor pattern. The material of the terminal electrodes T1 to T6 is preferably, for example, a conductor including Ag as a main component.

Frame-shaped insulating films (not shown) that cover outer edge portions of the terminal electrodes T1 to T6 are formed on the back surface of the magnetic layer S2. More specifically, after the terminal electrodes T1 to T6 are formed on the back surface of the magnetic layer S2, a paste of non-magnetic material (non-magnetic ferrite) is applied to cover the outer edge portions of the terminal electrodes T1 to T6 in the shape of frames by printing, and is fired to form the insulating films.

In the third step, the second conductor pattern portion 62 is provided on a back surface of the non-magnetic layer S3, the third conductor pattern portions 63 are provided on back surfaces of the non-magnetic layers S4 to S9, and the first conductor pattern portion 61 is provided on a back surface (principal surface) of the magnetic layer S10. More specifically, the second conductor pattern portion 62, which extends about one turn, for example, is formed on the back surface of the non-magnetic layer S3. The third conductor pattern portions 63, which each extend about one turn, for example, are formed on the back surfaces of the non-magnetic layers S4 to S9. The first conductor pattern portion 61, which extends about one turn, for example, is formed on the back surface of the magnetic layer S10. The material of each of the first conductor pattern portion 61, the second conductor pattern portion 62, and the third conductor pattern portions 63 is preferably, for example, a conductor including Ag as a main component.

In the fourth step, the auxiliary film 701 is provided on the first conductor pattern portion 61 on the back surface of the magnetic layer S10. The auxiliary film 701 is preferably, for example, a carbon film, and has the line width 821 (see FIG. 1B) less than the line width 811 (see FIG. 1B) of the first conductor pattern portion 61.

In the fifth step, the magnetic layer S2, the non-magnetic layer S3, the non-magnetic layer S4, the non-magnetic layer S5, the non-magnetic layer S6, the non-magnetic layer S7, the non-magnetic layer S8, the non-magnetic layer S9, and the magnetic layer S10 are stacked in that order. The magnetic layer S2 is the bottom layer of the multilayer body, and the magnetic layer S10 is the top layer of the multilayer body. More specifically, in the fifth step, the non-magnetic layer S9 is stacked on the magnetic layer S10 to cover the back surface on which the first conductor pattern portion 61 and the auxiliary film 701 are provided.

In the sixth step, the magnetic layers and the non-magnetic layers in a stacked state are pressed in the lamination direction D1, so that a portion of the first conductor pattern portion 61 on which the auxiliary film 701 is provided is positioned farther toward the magnetic layer S10 than is the remaining portion of the first conductor pattern portion 61.

In the seventh step, the multilayer body is sintered to form the first insulating pattern portion 71 having the line width δ21 less than the line width δ11 of the first conductor pattern portion 61. At this time, the auxiliary film 701 provided on the first conductor pattern portion 61 on the back surface of the magnetic layer S10 is burned so that the first insulating pattern portion 71, which is a void, is formed at the position where the auxiliary film 701 had been present.

The multilayer body 2 may include non-magnetic layers that are other than the non-magnetic layers S3 to S9 and that have no conductor pattern portions provided thereon. In addition, the multilayer body 2 may include magnetic layers that are other than the magnetic layers S2 and S10 and that have no conductor pattern portions provided thereon. These non-magnetic layers and magnetic layers are not illustrated or described herein.

### (3) Advantageous Effects

According to the antenna element 1 of the first preferred embodiment, the first conductor pattern portion 61 of the coil conductor 3 is provided between the first magnetic portion 51 and the first non-magnetic portion 41 (at the boundary between the first magnetic portion 51 and the first non-magnetic portion 41). Accordingly, the magnetic loss is less than that when the coil conductor 3 is covered with a magnetic portion.

In addition, according to the antenna element 1 of the first preferred embodiment, the first conductor pattern portion 61 disposed between the first non-magnetic portion 41 and the first magnetic portion 51 includes the first insulating pattern portion 71 provided on the first conductor pattern portion 61 at a side facing the second principal surface 22, the first insulating pattern portion 71 having the line width δ21 less than the line width δ11 of the first conductor pattern portion 61. Accordingly, the first conductor pattern portion 61 can be shaped to bulge toward the first principal surface 21 as a result of, for example, a pressing step, so that the direction of magnetic flux can be brought closer to the lamination direction D1 than to the direction D2 orthogonal or substantially orthogonal to the lamination direction D1. In particular, the side surface of the first conductor pattern portion 61 facing the first principal surface 21 protrudes by a greater amount than does the side surface of the first conductor pattern portion 61 facing the second principal surface 22. Therefore, the direction of the magnetic flux can be easily brought closer to the lamination direction D1. As a result, the communication performance of the antenna element 1 can be improved.

Thus, according to the antenna element 1 of the first preferred embodiment, the magnetic loss can be reduced and the communication performance of the antenna element 1 can be improved.

According to the antenna element 1 of the first preferred embodiment, the first insulating pattern portion 71 is a void disposed between the first conductor pattern portion 61 and another conductor (for example, one of the third conductor pattern portions 63). When another conductor is present around the first conductor pattern portion 61, a stray capacitance is generated between the first conductor pattern portion 61 and the other conductor. However, when a void is disposed between the first conductor pattern portion 61 and the other conductor, the stray capacitance generated between the first conductor pattern portion 61 and the other conductor is less than that when no void is provided between the first conductor pattern portion 61 and the other conductor (when space between the first conductor pattern portion 61 and the other conductor is entirely filled with the first non-magnetic portion 41). More specifically, since the first insulating pattern portion 71 is a void, the relative dielectric constant of the first insulating pattern portion 71 is less than that of the first non-magnetic portion 41. Therefore, the stray capacitance generated between the first conductor pattern portion 61 and the other conductor is less than that when the first insulating pattern portion 71 is not provided (when the space between the first conductor pattern portion 61 and the other conductor is entirely filled with the first non-magnetic portion 41). As a result, the Q factor of the antenna element 1 can be increased.

According to the above-described method for manufacturing the antenna element 1 of the first preferred embodiment, the first conductor pattern portion 61 of the coil conductor 3 of the manufactured antenna element 1 is disposed between the magnetic layer S10 that forms the first magnetic portion 51 and the non-magnetic layer S9 included in the first non-magnetic portion 41 (at the boundary between the magnetic layer S10 and the non-magnetic layer S9). Accordingly, the magnetic loss of the antenna element 1 is less than that when the coil conductor 3 is covered with a magnetic portion.

In addition, according to the above-described method for manufacturing the antenna element 1 of the first preferred embodiment, the first conductor pattern portion 61 disposed between the non-magnetic layer S9 and the magnetic layer S10 includes the first insulating pattern portion 71 provided on the first conductor pattern portion 61 at a side facing the non-magnetic layer S9, the first insulating pattern portion 71 being formed from the auxiliary film 701 having the line width δ21 less than the line width δ11 of the first conductor pattern portion 61. Accordingly, the first conductor pattern portion 61 of the antenna element 1 can be shaped to bulge toward the magnetic layer S10, so that the direction of the magnetic flux ϕ1 can be brought closer to the lamination direction D1 than to a direction orthogonal or substantially orthogonal to the lamination direction D1 (for example, direction D2). In particular, the side surface of the first conductor pattern portion 61 facing the magnetic layer S10 protrudes by a greater amount than does the side surface of the first conductor pattern portion 61 facing the non-magnetic layer S9. Therefore, the direction of the magnetic flux ϕ1 can be easily brought closer to the lamination direction D1. As a result, the communication performance of the antenna element 1 can be improved.

Thus, according to the above-described method for manufacturing the antenna element 1 of the first preferred embodiment, the antenna element 1 with which the magnetic loss can be reduced and the communication performance of the antenna element 1 can be improved can be manufactured.

### (4) Modifications

Modifications of the first preferred embodiment will now be described.

According to a modification of the first preferred embodiment, the first insulating pattern portion 71 may be made of insulating paste instead of being a void, the insulating paste having a relative dielectric constant less than that of the first non-magnetic portion 41. In this modification, the first insulating pattern portion 71 is provided by placing the insulating paste on the first conductor pattern portion 61 at the side facing the second principal surface 22.

According to a modification of the first preferred embodiment, the coil conductor 3 may include only one third conductor pattern portion 63. Thus, the coil conductor 3 is only required to include at least one third conductor pattern portion 63.

Each of the antenna elements according to the above-described modifications also has advantageous effects similar to those of the antenna element 1 according to the first preferred embodiment.

### Second Preferred Embodiment

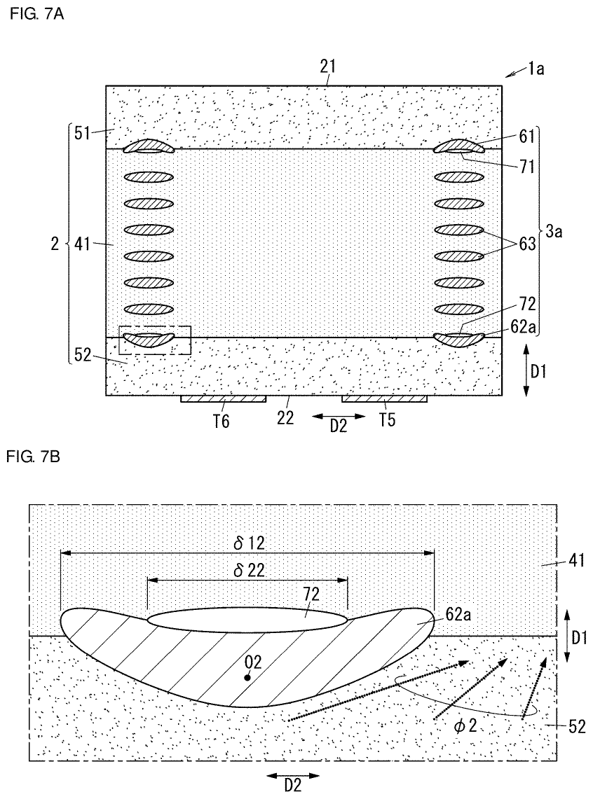

As illustrated in FIGS. 7A and 7B, an antenna element 1a according to a second preferred embodiment of the present invention differs from the antenna element 1 according to the first preferred embodiment (see FIGS. 1A and 1B) in that a second insulating pattern portion 72 is provided on a second conductor pattern portion 62a. Components of the antenna element 1a according to the second preferred embodiment the same as or similar to those of the antenna element 1 according to the first preferred embodiment are denoted by the same reference numerals, and description thereof is omitted.

The antenna element 1a according to the second preferred embodiment includes a coil conductor 3a illustrated in FIG. 7A instead of the coil conductor 3 according to the first preferred embodiment. Similarly to the first preferred embodiment, the antenna element 1a according to the second preferred embodiment includes the second magnetic portion 52 disposed on the first non-magnetic portion 41 at a side facing the second principal surface (mounting surface).

The coil conductor 3a includes the second conductor pattern portion 62a in place of the second conductor pattern portion 62 according to the first preferred embodiment. In addition, the coil conductor 3a additionally includes the second insulating pattern portion 72. Structures and functions of the coil conductor 3a of the second preferred embodiment the same as or similar to those of the coil conductor 3 of the first preferred embodiment (see FIG. 1A) will not be described.

Similarly to the second conductor pattern portion 62 according to the first preferred embodiment, the second conductor pattern portion 62a is disposed between the first non-magnetic portion 41 and the second magnetic portion 52 in the lamination direction D1.

The second insulating pattern portion 72 is provided on the second conductor pattern portion 62a at a side facing the first principal surface 21, and has a line width δ22 less than a line width δ12 of the second conductor pattern portion 62. The second insulating pattern portion 72 overlaps the second conductor pattern portion 62a in plan view as viewed in the lamination direction D1. In other words, the second insulating pattern portion 72, which has the line width δ22 less than the line width δ12 of the second conductor pattern portion 62a, extends along the second conductor pattern portion 62a. The second insulating pattern portion 72 corresponds to a second insulating portion.

The line width δ22 of the second insulating pattern portion 72 is less than the line width δ12 of the second conductor pattern portion 62a, and the thickness of the second insulating pattern portion 72 is less than the thickness of the second conductor pattern portion 62a. The relationship between the dimensions of the second insulating pattern portion 72 and the second conductor pattern portion 62a is not limited by the above description.

Since the second insulating pattern portion 72 is provided on the second conductor pattern portion 62a at the side facing the first principal surface 21, the second conductor pattern portion 62a bulges toward the second principal surface 22 (mounting surface).

The second conductor pattern portion 62a is shaped as illustrated in FIG. 7B. Thus, the second conductor pattern portion 62a has a convex shape. In other words, a central portion of the second conductor pattern portion 62a protrudes farther toward the second magnetic portion 52 than do both end portions of the second conductor pattern portion 62a. In other words, a centroid O2 of the second conductor pattern portion 62a is shifted toward the second magnetic portion 52 in the lamination direction D1. More specifically, the centroid O2 of the second conductor pattern portion 62a is closer to the second principal surface 22 than is the centroid of a flat second conductor pattern portion in the lamination direction D1. The second conductor pattern portion 62a does not necessarily have a sharply protruding shape, and may have a gently protruding shape.

The multilayer body including the first non-magnetic portion 41, the first magnetic portion 51, and the second magnetic portion 52 may be pressed in the lamination direction D1 after an auxiliary film is provided on the second conductor pattern portion 62a at a position where the second insulating pattern portion 72 is to be formed. In this case, as a result of being pressed in the lamination direction D1, the second conductor pattern portion 62a is shaped such that the central portion thereof protrudes farther toward the second principal surface 22 than do both end portions thereof. When the above-described multilayer body is sintered while being pressed in the lamination direction D1, the auxiliary film is burned so that the second insulating pattern portion 72 is formed. The third conductor pattern portions 63, which are not provided with an insulating pattern portion similar to the second insulating pattern portion 72, are not shaped similarly to the second conductor pattern portion 62a, and have a flat or substantially flat shape.

The second insulating pattern portion 72 is a void. In other words, the second insulating pattern portion 72 is a void pattern portion having a void pattern.

The flow of magnetic flux ϕ2 will now be described with reference to FIG. 7B.

As illustrated in FIG. 7B, the second insulating pattern portion 72 having the line width δ22 less than the line width δ12 of the second conductor pattern portion 62a is provided on the second conductor pattern portion 62a at a side facing the first principal surface 21. Accordingly, as described above, the second conductor pattern portion 62a bulges toward the second principal surface 22.

Since the second conductor pattern portion 62a bulges toward the second principal surface 22, as shown by the arrows in FIG. 7B, the direction of the magnetic flux ϕ2 in the second magnetic portion 52 can be brought closer to the lamination direction D1 from the direction D2 orthogonal or substantially orthogonal to the lamination direction D1. In other words, a component in the lamination direction D1 can be increased. As a result, the communication performance of the antenna element 1a is improved.

In contrast, in a comparative example in which the second insulating pattern portion 72 is not provided, the second conductor pattern portion does not have a bulging shape. In this comparative example, the direction of magnetic flux in the second magnetic portion is closer to the direction D2 orthogonal to the lamination direction D1 than that in the second preferred embodiment. Therefore, the component in the lamination direction D1 is small, and the communication performance of the antenna element cannot be easily improved.

As described above, according to the antenna element 1a of the second preferred embodiment, the second conductor pattern portion 62a bulges toward the second principal surface 22, so that the communication performance of the antenna element 1a is higher than that in the comparative example in which the second conductor pattern portion does not have a bulging shape.

A non-limiting example of a method for manufacturing the antenna element 1a according to the second preferred embodiment will now be described. The antenna element 1a according to the second preferred embodiment is manufactured by first to seventh steps.

First, similarly to the first preferred embodiment, the first to third steps are performed. More specifically, in the first step, the non-magnetic layers S3 to S9 (see FIGS. 5 and 6) and the magnetic layers S2 and S10 (see FIGS. 5 and 6) are prepared. In the second step, the terminal electrodes T1 to T6 (see FIG. 5) are formed on the back surface of the magnetic layer S2. In the third step, the second conductor pattern portion 62a is provided on the back surface of the non-magnetic layer S3, the third conductor pattern portions 63 are provided on the back surfaces of the non-magnetic layers S4 to S9, and the first conductor pattern portion 61 is provided on the back surface of the magnetic layer S10.

In the fourth step of the second preferred embodiment, the auxiliary film 701 is formed on the first conductor pattern portion 61 on the back surface of the magnetic layer S10, and another auxiliary film is formed on the second conductor pattern portion 62a on the back surface of the non-magnetic layer S3. Similarly to the auxiliary film 701 formed on the first conductor pattern portion 61, the auxiliary film formed on the second conductor pattern portion 62a is preferably, for example, a carbon film. The auxiliary film formed on the second conductor pattern portion 62a has a line width less than the line width δ12 of the second conductor pattern portion 62a.

After that, similarly to the first preferred embodiment, the fifth step is performed. More specifically, in the fifth step, the magnetic layer S2, the non-magnetic layer S3, the non-magnetic layer S4, the non-magnetic layer S5, the non-magnetic layer S6, the non-magnetic layer S7, the non-magnetic layer S8, the non-magnetic layer S9, and the magnetic layer S10 are stacked in that order.

In the sixth step of the second preferred embodiment, similarly to the first preferred embodiment, the magnetic layers and the non-magnetic layers in a stacked state are pressed in the lamination direction D1, so that a portion of the first conductor pattern portion 61 on which the auxiliary film 701 is provided is positioned farther toward the magnetic layer S10 than is the remaining portion of the first conductor pattern portion 61. In addition, in the second preferred embodiment, a portion of the second conductor pattern portion 62a on which the auxiliary film is provided is positioned farther toward the magnetic layer S2 than is the remaining portion of the second conductor pattern portion 62a.

In the seventh step of the second preferred embodiment, similarly to the first preferred embodiment, the multilayer body is sintered to form the first insulating pattern portion 71, which is a void. In addition, in the second preferred embodiment, the second insulating pattern portion 72 having the line width δ22 less than the line width δ12 of the second conductor pattern portion 62a is formed. At this time, the auxiliary film formed on the second conductor pattern portion 62a on the back surface of the non-magnetic layer S3 is burned so that the second insulating pattern portion 72, which is a void, is formed at the position where the auxiliary film had been present.

As described above, according to the antenna element 1a of the second preferred embodiment, the second conductor pattern portion 62a disposed between the first non-magnetic portion 41 and the second magnetic portion 52 has the second insulating pattern portion 72 on the second conductor pattern portion 62a at a side facing the first principal surface 21, the second insulating pattern portion 72 having the line width δ22 less than the line width δ12 of the second conductor pattern portion 62a. Accordingly, the second conductor pattern portion 62a can be shaped to bulge toward the second principal surface 22, so that the direction of the magnetic flux ϕ2 can be brought closer to the lamination direction D1 than to the direction orthogonal or substantially orthogonal to the lamination direction D1 (for example, direction D2). As a result, the communication performance of the antenna element 1a is further improved.

According to a modification of the second preferred embodiment, the second insulating pattern portion 72 may be formed of insulating paste instead of being a void, the insulating paste having a relative dielectric constant less than that of the first non-magnetic portion 41. In this modification, the second insulating pattern portion 72 is formed by placing the insulating paste on the second conductor pattern portion 62a at the side facing the first principal surface 21.

The antenna element according to the above-described modification also has advantageous effects similar to those of the antenna element 1a according to the second preferred embodiment.

### Third Preferred Embodiment

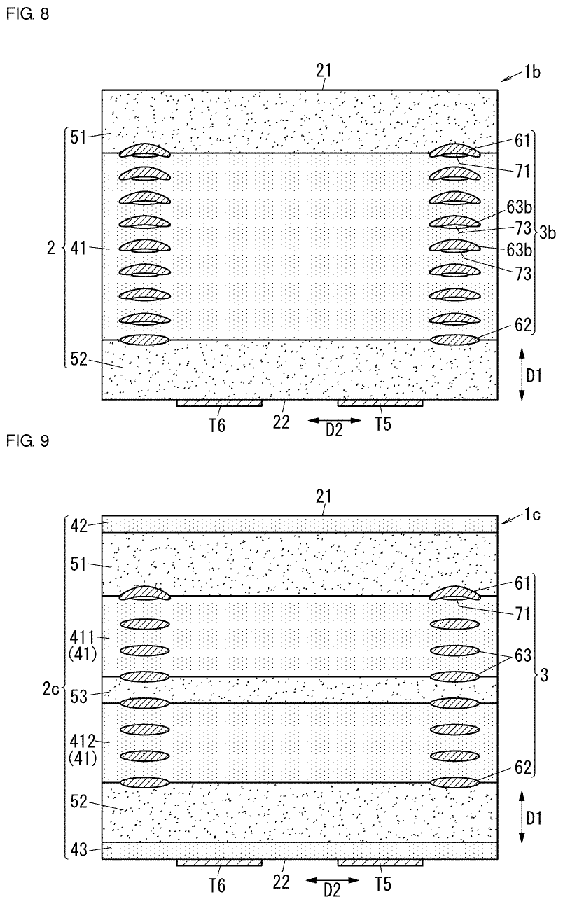

As illustrated in FIG. 8, an antenna element 1b according to a third preferred embodiment of the present invention differs from the antenna element 1 according to the first preferred embodiment (see FIG. 1A) in that a plurality of third insulating pattern portions 73 (seven third insulating pattern portions 73 in the illustrated example) are provided. Components of the antenna element 1b according to the third preferred embodiment the same as or similar to those of the antenna element 1 according to the first preferred embodiment are denoted by the same reference numerals, and description thereof is omitted.

The antenna element 1b according to the third preferred embodiment includes a coil conductor 3b illustrated in FIG. 8 in place of the coil conductor 3 according to the first preferred embodiment.

The coil conductor 3b includes the first conductor pattern portion 61, the second conductor pattern portion 62, a plurality of third conductor pattern portions 63b (seven third conductor pattern portions 63b in the illustrated example), the first insulating pattern portion 71, and the plurality of third insulating pattern portions 73 (seven third insulating pattern portions 73 in the illustrated example). Structures and functions of the coil conductor 3b of the third preferred embodiment the same as or similar to those of the coil conductor 3 of the first preferred embodiment (see FIG. 1A) will not be described.

Similarly to the third conductor pattern portions 63 of the first preferred embodiment, the third conductor pattern portions 63b are each disposed in the first non-magnetic portion 41.

The third insulating pattern portions 73 are in one-to-one correspondence with the third conductor pattern portions 63b, and each third insulating pattern portion 73 is provided on a corresponding one of the third conductor pattern portions 63b at a side facing the second principal surface 22. Each third insulating pattern portion 73 has a line width less than a line width of the corresponding third conductor pattern portion 63b. Each third insulating pattern portion 73 overlaps the corresponding third conductor pattern portion 63b in plan view as viewed in the lamination direction D1. In other words, the third insulating pattern portions 73 having the line widths less than the line widths of the third conductor pattern portions 63b extend along the third conductor pattern portions 63b. The third insulating pattern portions 73 correspond to a third insulating portion.

The line widths of the third insulating pattern portions 73 are less than the line widths of the third conductor pattern portions 63b, and the thicknesses of the third insulating pattern portions 73 are less than the thicknesses of the third conductor pattern portions 63b. The dimensions of the third insulating pattern portions 73 and the third conductor pattern portions 63b are not limited by the above description.

Since the third insulating pattern portions 73 are provided on the third conductor pattern portions 63b at sides facing the second principal surface 22, the third conductor pattern portions 63b bulge toward the first principal surface 21 (radiation surface).

The third conductor pattern portions 63b are shaped as illustrated in FIG. 8. Thus, the third conductor pattern portions 63b have a convex shape. In other words, a central portion of each third conductor pattern portion 63b protrudes farther toward the first magnetic portion 51 than do both end portions of the third conductor pattern portion 63b. In other words, a centroid of each third conductor pattern portion 63b is shifted toward the first magnetic portion 51 in the lamination direction D1. More specifically, the centroid of each third conductor pattern portion 63b is closer to the first principal surface 21 than is the centroid of a flat third conductor pattern portion in the lamination direction D1. Each third conductor pattern portion 63b does not necessarily have a sharply protruding shape, and may have a gently protruding shape.

The multilayer body including the first non-magnetic portion 41, the first magnetic portion 51, and the second magnetic portion 52 may be sintered while being pressed in the lamination direction D1 after the third insulating pattern portions 73 are formed on the third conductor pattern portions 63b. In this case, as a result of being pressed in the lamination direction D1, each third conductor pattern portion 63b is shaped such that the central portion thereof protrudes farther toward the first principal surface 21 than do both end portions thereof. The second conductor pattern portion 62, which is not provided with an insulating pattern portion similar to the second insulating pattern portion 72, is not shaped similarly to the third conductor pattern portions 63b, and has a flat or substantially flat shape.

When the third insulating pattern portions 73 are provided on the corresponding third conductor pattern portions 63b as in the third preferred embodiment, each third conductor pattern portion 63b bulges toward the first principal surface 21 as a result of being pressed. At this time, depending on the degree to which each third conductor pattern portion 63b bulges, the degree to which the first conductor pattern portion 61 bulges can be increased because the thicknesses of the third insulating pattern portions 73 that are disposed next to the third conductor pattern portions 63b are accumulated in the lamination direction D1. In other words, when the third insulating pattern portions 73 are provided on the corresponding third conductor pattern portions 63b, each third conductor pattern portion 63b bulges toward the first principal surface 21 as a result of a pressing step. At this time, depending on the degree to which each third conductor pattern portion 63b bulges, the degree to which the first conductor pattern portion 61, which is disposed next to the third conductor pattern portions 63b, bulges can be increased in the lamination direction D1. As the degree to which the first conductor pattern portion 61 bulges increases, the direction of the magnetic flux ϕ1 (see FIG. 4A) in the first magnetic portion 51 can be brought closer to the lamination direction D1.

The third insulating pattern portions 73 are voids. In other words, the third insulating pattern portions 73 are void pattern portions having a void pattern.

Since the third insulating pattern portions 73 are voids, the relative dielectric constant of each third insulating pattern portion 73 is less than that of the first non-magnetic portion 41. Therefore, the relative dielectric constant between two third conductor pattern portions 63b that are adjacent to each other in the lamination direction D1 is closer to 1 than that when the third insulating pattern portions 73 are not provided. Thus, the stray capacitance between the two third conductor pattern portions 63b that are adjacent to each other in the lamination direction D1 and the stray capacitance between the third conductor pattern portion 63b that is closest to the second conductor pattern portion 62 and the second conductor pattern portion 62 can be reduced. As a result, the Q factor of the antenna element 1b can be increased.

In addition, since the third insulating pattern portions 73 are voids, stress generated in the first non-magnetic portion 41 due to the difference in coefficient of linear expansion between the first non-magnetic portion 41 and the first magnetic portion 51 can be reduced. In addition, stress generated in the first non-magnetic portion 41 due to the difference in coefficient of linear expansion between the first non-magnetic portion 41 and the second magnetic portion 52 can also be reduced. Accordingly, formation of cracks in a direction orthogonal or substantially orthogonal to the lamination direction D1 (for example, direction D2) can be reduced.

A non-limiting example of a method for manufacturing the antenna element 1b according to the third preferred embodiment will now be described. The antenna element 1b according to the third preferred embodiment is manufactured by first to seventh steps.

First, similarly to the first preferred embodiment, the first to third steps are performed. More specifically, in the first step, the non-magnetic layers S3 to S9 (see FIGS. 5 and 6) and the magnetic layers S2 and S10 (see FIGS. 5 and 6) are prepared. In the second step, the terminal electrodes T1 to T6 (see FIG. 5) are formed on the back surface of the magnetic layer S2. In the third step, the second conductor pattern portion 62 is provided on the back surface of the non-magnetic layer S3, the third conductor pattern portions 63b are provided on the back surfaces of the non-magnetic layers S4 to S9, and the first conductor pattern portion is provided on the back surface (principal surface) of the magnetic layer S10.

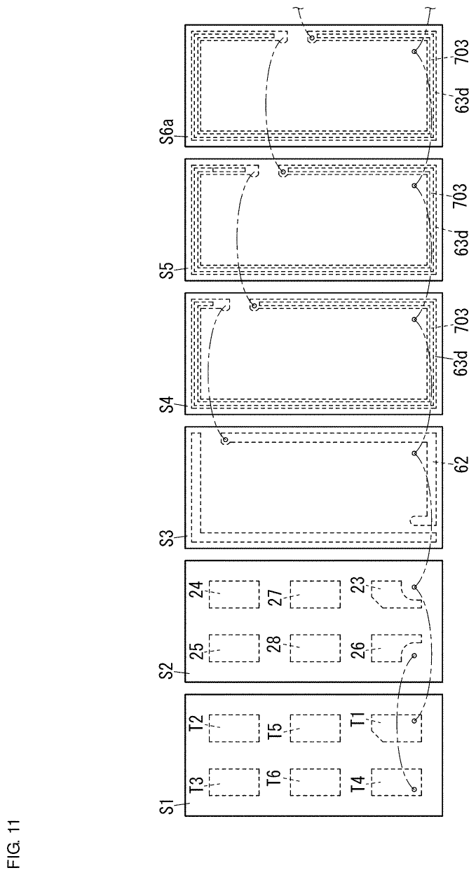

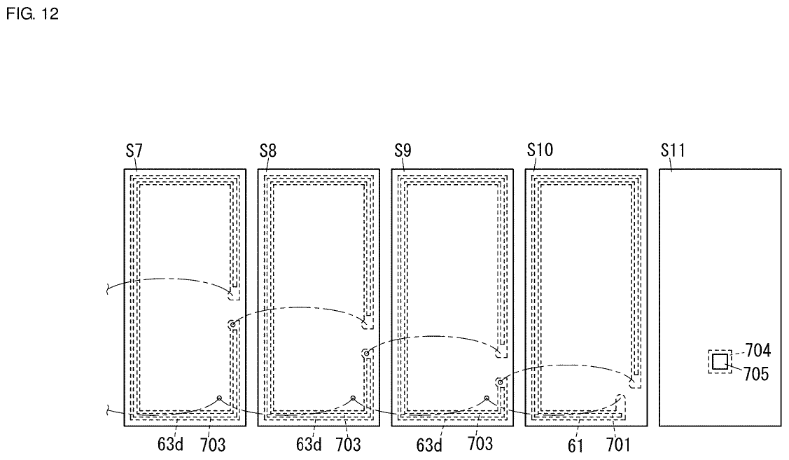

In the fourth step of the third preferred embodiment, the auxiliary film 701 (see FIG. 12) is provided on the first conductor pattern portion 61 on the back surface of the magnetic layer S10, and auxiliary films 703 (see FIGS. 11 and 12) are provided on the third conductor pattern portions 63b on the back surfaces of the non-magnetic layers S4 to S9. Similarly to the auxiliary film 701 provided on the first conductor pattern portion 61, the auxiliary films 703 provided on the third conductor pattern portions 63b are preferably, for example, carbon films. The auxiliary films 703 provided on the third conductor pattern portions 63b have line widths less than the line widths of the third conductor pattern portions 63b.

After that, similarly to the first preferred embodiment, the fifth step is performed. More specifically, in the fifth step, the magnetic layer S2, the non-magnetic layer S3, the non-magnetic layer S4, the non-magnetic layer S5, the non-magnetic layer S6, the non-magnetic layer S7, the non-magnetic layer S8, the non-magnetic layer S9, and the magnetic layer S10 are stacked in that order.

In the sixth step of the third preferred embodiment, similarly to the first preferred embodiment, the magnetic layers and the non-magnetic layers in a stacked state are pressed in the lamination direction D1, so that a portion of the first conductor pattern portion 61 on which the auxiliary film 701 is provided is positioned farther toward the magnetic layer S10 than is the remaining portion of the first conductor pattern portion 61. In addition, in the third preferred embodiment, portions of the third conductor pattern portions 63b on which the auxiliary films 703 are provided are positioned farther toward the magnetic layer S10 than are the remaining portions of the third conductor pattern portions 63b.

In the seventh step of the third preferred embodiment, similarly to the first preferred embodiment, the multilayer body is sintered to form the first insulating pattern portion 71, which is a void. In addition, in the third preferred embodiment, the third insulating pattern portions 73 having line widths less than the line widths of the third conductor pattern portions 63b are formed. At this time, the auxiliary films 703 formed on the third conductor pattern portions 63b on the back surfaces of the non-magnetic layers S4 to S9 are burned so that the third insulating pattern portions 73, which are voids, are formed at the positions where the auxiliary films 703 have been present.

As described above, according to the antenna element 1b of the third preferred embodiment, the third conductor pattern portions 63b disposed in the first non-magnetic portion 41 have the third insulating pattern portions 73 provided thereon, the third insulating pattern portions 73 having line widths less than the line widths of the third conductor pattern portions 63b. Accordingly, the thickness of the first insulating pattern portion 71 and the thicknesses of the third insulating pattern portions 73 are accumulated in the lamination direction D1, so that the degree to which the first conductor pattern portion 61 bulges can be increased. As a result, the direction of the magnetic flux can be brought closer to the lamination direction D1.

In addition, according to the antenna element 1b of the third preferred embodiment, when the third insulating pattern portions 73 are voids, the stray capacitances between the second conductor pattern portion 62 and the third conductor pattern portions 63b can be reduced. Therefore, the Q factor of the antenna element 1b can be increased.

In addition, according to the antenna element 1b of the third preferred embodiment, when the third insulating pattern portions 73 are voids, stress generated in a non-magnetic portion (for example, the first non-magnetic portion 41) due to the difference in coefficient of linear expansion between the non-magnetic portion and a magnetic portion (for example, the first magnetic portion 51) can be reduced. Accordingly, formation of cracks in the direction D2 orthogonal or substantially orthogonal to the lamination direction D1 can be reduced in regions between the conductor patterns (regions between the first conductor pattern portion 61 and the third conductor pattern portions 63b and between two third conductor pattern portions 63b).

According to a modification of the third preferred embodiment, the coil conductor 3b may include only one third conductor pattern portion 63b. Thus, the coil conductor 3b is only required to include at least one third conductor pattern portion 63b.

According to a modification of the third preferred embodiment, the coil conductor 3b may include only one third insulating pattern portion 73. Thus, the coil conductor 3b is only required to include at least one third insulating pattern portion 73.

According to a modification of the third preferred embodiment, the third insulating pattern portions 73 may each be formed of insulating paste instead of being a void, the insulating paste having a relative dielectric constant less than that of the first non-magnetic portion 41. In this modification, the third insulating pattern portions 73 are formed by placing the insulating paste on each of the third conductor pattern portions 63b at the side facing the second principal surface 22.

Each of the antenna elements according to the above-described modifications also has advantageous effects similar to those of the antenna element 1b according to the third preferred embodiment.

### Fourth Preferred Embodiment

As illustrated in FIG. 9, an antenna element 1c according to a fourth preferred embodiment of the present invention differs from the antenna element 1 according to the first preferred embodiment (see FIG. 1A) in that a third magnetic portion 53 is provided at an intermediate position of a first non-magnetic portion 41. Components of the antenna element 1c according to the fourth preferred embodiment the same as or similar to those of the antenna element 1 according to the first preferred embodiment are denoted by the same reference numerals, and description thereof is omitted.

The antenna element 1c according to the fourth preferred embodiment includes a multilayer body 2c illustrated in FIG. 9 in place of the multilayer body 2 according to the first preferred embodiment.

The multilayer body 2c further includes the third magnetic portion 53. Structures and functions of the multilayer body 2c of the fourth preferred embodiment the same as or similar to those of the multilayer body 2 of the first preferred embodiment (see FIG. 1A) will not be described.

The third magnetic portion 53 is provided to divide the first non-magnetic portion 41 into two sections in the lamination direction D1. The third magnetic portion 53 is provided at an intermediate position of the first non-magnetic portion 41. The third magnetic portion 53 is formed of at least one magnetic layer including a magnetic layer S6a (see FIG. 11). The magnetic layer S6a that forms the third magnetic portion 53 is a sintered body of, for example, a magnetic ferrite of a low temperature co-fired ceramic.

When the third magnetic portion 53 is provided at an intermediate position of the first non-magnetic portion 41 as in the fourth preferred embodiment, the first non-magnetic portion 41 can be divided into two non-magnetic portions 411 and 412 having small thicknesses. Accordingly, tensile stress applied to the first magnetic portion 51 and the second magnetic portion 52 by the first non-magnetic portion 41 (stress generated in a direction orthogonal or substantially orthogonal to the lamination direction D1 due to the difference in coefficient of linear expansion between the first non-magnetic portion 41 and the first magnetic portion 51 and between the first non-magnetic portion 41 and the second magnetic portion 52) can be reduced. As a result, formation of cracks in the lamination direction D1 in the first magnetic portion 51 and the second magnetic portion 52 can be reduced.

The multilayer body 2c further includes a second non-magnetic portion 42. The second non-magnetic portion 42 is closer to the first principal surface 21 than is the first magnetic portion 51 in the lamination direction D1. The second non-magnetic portion 42 includes a non-magnetic layer S11 (see FIG. 12). The non-magnetic layer S11 of the second non-magnetic portion 42 is preferably a sintered body of, for example, a non-magnetic ferrite of a low temperature co-fired ceramic.

In addition, the multilayer body 2c further includes a third non-magnetic portion 43. The third non-magnetic portion 43 is closer to the second principal surface 22 than is the second magnetic portion 52 in the lamination direction D1. The third non-magnetic portion 43 includes a non-magnetic layer S1 (see FIG. 11). The non-magnetic layer S1 that forms the third non-magnetic portion 43 is preferably a sintered body of, for example, a non-magnetic ferrite of a low temperature co-fired ceramic.

As described above, both ends of the multilayer body 2c in the lamination direction D1 are non-magnetic portions. In general, magnetic portions are more brittle than non-magnetic portions. Therefore, when both ends of the multilayer body 2c are non-magnetic portions, the mechanical strength of the multilayer body 2c can be increased.

A non-limiting example of a method for manufacturing the antenna element 1c according to the fourth preferred embodiment will now be described. The antenna element 1c according to the fourth preferred embodiment is manufactured by first to eighth steps.

In the first step, the non-magnetic layers S1, S3 to S5, S7 to S9, and S11 (see FIGS. 11 and 12) and the magnetic layers S2 and S10 (see FIGS. 11 and 12) are prepared. In addition, in the first step of the fourth preferred embodiment, the magnetic layer S6a (see FIG. 11) is prepared in place of the non-magnetic layer S6 according to the first preferred embodiment.

In the second step, the terminal electrodes T1 to T6 (see FIG. 11) are formed on a back surface of the non-magnetic layer S1, and a plurality of conductors 23 to 28 (see FIG. 11) are formed on the back surface of the magnetic layer S2.

Similarly to the first preferred embodiment, the third step and the fourth step are performed. More specifically, in the third step, similarly to the first preferred embodiment, the second conductor pattern portion 62 is formed on the back surface of the non-magnetic layer S3, the third conductor pattern portions 63 are formed on the back surfaces of the non-magnetic layers S4, S5, and S7 to S9 and the magnetic layer S6a, and the first conductor pattern portion 61 is formed on the back surface of the magnetic layer S10. In the fourth step, the auxiliary film 701 is formed on the first conductor pattern portion 61 on the back surface of the magnetic layer S10.

In the fifth step, a position mark 705 (see FIG. 12) is formed on a front surface of the non-magnetic layer S11, and a conductor 704 (see FIG. 12) is formed on a back surface of the non-magnetic layer S11.

In the sixth step, the non-magnetic layer S1, the magnetic layer S2, the non-magnetic layer S3, the non-magnetic layer S4, the non-magnetic layer S5, the magnetic layer S6a, the non-magnetic layer S7, the non-magnetic layer S8, the non-magnetic layer S9, the magnetic layer S10, and the non-magnetic layer S11 are stacked in that order.

After that, the seventh step and the eighth step are performed similarly to the sixth step and the seventh step according to the first preferred embodiment. More specifically, in the seventh step, the magnetic layers and the non-magnetic layers in a stacked state are pressed in the lamination direction D1, so that a portion of the first conductor pattern portion 61 on which the auxiliary film 701 is provided is positioned farther toward the magnetic layer S10 than is the remaining portion of the first conductor pattern portion 61. In the eighth step, the multilayer body is sintered to form the first insulating pattern portion 71, which is a void.

As described above, according to the antenna element 1c of the fourth preferred embodiment, the third magnetic portion 53 is provided to divide the first non-magnetic portion 41 into at least two sections. Thus, the first non-magnetic portion 41 can be divided into two sections which each have a small thickness, so that tensile stress applied to the magnetic portions, such as the first magnetic portion 51, can be reduced. As a result, formation of cracks in the lamination direction D1 in the magnetic portions can be reduced.

According to the antenna element 1c of the fourth preferred embodiment, the second non-magnetic portion 42, which has a strength higher than that of the first magnetic portion 51, is disposed closer to the first principal surface 21 than is the first magnetic portion 51 (provided on the outer side of the first magnetic portion 51). In addition, the third non-magnetic portion 43, which has a strength higher than that of the second magnetic portion 52, is disposed closer to the second principal surface 22 than is the second magnetic portion 52 (provided on the outer side of the second magnetic portion 52). Accordingly, the strength of the antenna element 1c can be increased.

According to a modification of the fourth preferred embodiment, the multilayer body 2c may include a plurality of third magnetic portions 53. In this modification, the third magnetic portions 53 are provided to divide the first non-magnetic portion 41 into two or more sections.

The antenna element according to the above-described modification also has advantageous effects similar to those of the antenna element 1c according to the fourth preferred embodiment.

### Fifth Preferred Embodiment

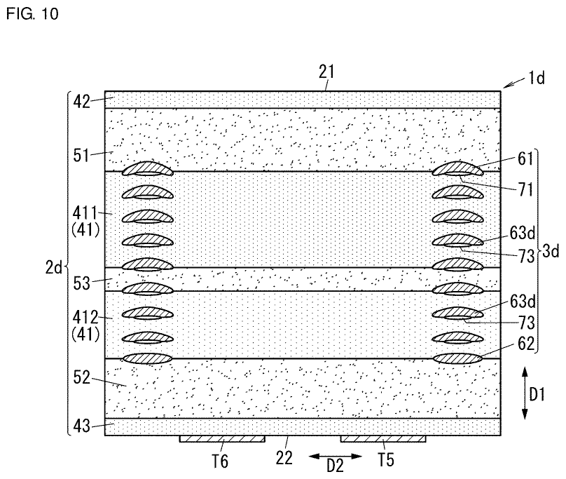

As illustrated in FIG. 10, an antenna element 1d according to a fifth preferred embodiment of the present invention differs from the antenna element 1 according to the first preferred embodiment (see FIG. 1A) in that the third insulating pattern portions 73 are provided on third conductor pattern portions 63d and the third magnetic portion 53 is provided at an intermediate position of a first non-magnetic portion 41. Components of the antenna element 1d according to the fifth preferred embodiment the same as or similar to those of the antenna element 1 according to the first preferred embodiment are denoted by the same reference numerals, and description thereof is omitted.

The antenna element 1d according to the fifth preferred embodiment includes a multilayer body 2d and a coil conductor 3d illustrated in FIG. 10 in place of the multilayer body 2 and the coil conductor 3 according to the first preferred embodiment.

The multilayer body 2d further includes the third magnetic portion 53. Structures and functions of the multilayer body 2d of the fifth preferred embodiment the same as or similar to those of the multilayer body 2 of the first preferred embodiment (see FIG. 1A) will not be described.

The third magnetic portion 53 is provided to divide the first non-magnetic portion 41 into two sections in the lamination direction D1. The third magnetic portion 53 is provided at an intermediate position of the first non-magnetic portion 41. The third magnetic portion 53 includes at least one magnetic layer including a magnetic layer S6a (see FIG. 11). The magnetic layer S6a of the third magnetic portion 53 is preferably a sintered body of, for example, a magnetic ferrite of a low temperature co-fired ceramic.

When the third magnetic portion 53 is provided at an intermediate position of the first non-magnetic portion 41 as in the fifth preferred embodiment, the first non-magnetic portion 41 can be divided into two non-magnetic portions 411 and 412 having small thicknesses. Accordingly, tensile stress applied to the first magnetic portion 51 and the second magnetic portion 52 by the first non-magnetic portion 41 (stress in a direction orthogonal to the lamination direction D1) can be reduced. As a result, formation of cracks in the lamination direction D1 in the first magnetic portion 51 and the second magnetic portion 52 can be reduced.

The multilayer body 2d further includes the second non-magnetic portion 42. The second non-magnetic portion 42 is closer to the first principal surface 21 than is the first magnetic portion 51 in the lamination direction D1. The second non-magnetic portion 42 is formed of the non-magnetic layer S11 (see FIG. 12). The non-magnetic layer S11 that forms the second non-magnetic portion 42 is a sintered body of, for example, a non-magnetic ferrite of a low temperature co-fired ceramic.

In addition, the multilayer body 2d further includes the third non-magnetic portion 43. The third non-magnetic portion 43 is closer to the second principal surface 22 than is the second magnetic portion 52 in the lamination direction D1. The third non-magnetic portion 43 includes the non-magnetic layer S1 (see FIG. 11). The non-magnetic layer S1 of the third non-magnetic portion 43 is preferably a sintered body of, for example, a non-magnetic ferrite of a low temperature co-fired ceramic.

As described above, both ends of the multilayer body 2d in the lamination direction D1 are non-magnetic portions. In general, magnetic portions are more brittle than non-magnetic portions. Therefore, when both ends of the multilayer body 2d are non-magnetic portions, the mechanical strength of the multilayer body 2d can be increased.

The coil conductor 3d includes the first conductor pattern portion 61, the second conductor pattern portion 62, the plurality of third conductor pattern portions 63d (seven third conductor pattern portions 63d in the illustrated example), the first insulating pattern portion 71, and the plurality of third insulating pattern portions 73 (seven third insulating pattern portions 73 in the illustrated example). Structures and functions of the coil conductor 3d of the fifth preferred embodiment the same as or similar to those of the coil conductor 3 of the first preferred embodiment (see FIG. 1A) will not be described.

Similarly to the third conductor pattern portions 63 of the first preferred embodiment, some of the third conductor pattern portions 63d are disposed in the first non-magnetic portion 41. The remaining third conductor pattern portions 63d are provided at the boundaries between the first non-magnetic portion 41 and the third magnetic portion 53.

The third insulating pattern portions 73 are in one-to-one correspondence with the third conductor pattern portions 63d, and each third insulating pattern portion 73 is provided on a corresponding one of the third conductor pattern portions 63d at a side facing the second principal surface 22. Each third insulating pattern portion 73 has a line width less than a line width of the corresponding third conductor pattern portion 63d. Each third insulating pattern portion 73 overlaps the corresponding third conductor pattern portion 63d in plan view as viewed in the lamination direction D1. In other words, the third insulating pattern portions 73 having the line widths less than the line widths of the third conductor pattern portions 63d extend along the third conductor pattern portions 63d.

The line widths of the third insulating pattern portions 73 are less than the line widths of the third conductor pattern portions 63d, and the thicknesses of the third insulating pattern portions 73 are less than the thicknesses of the third conductor pattern portions 63d. The dimensions of the third insulating pattern portions 73 and the third conductor pattern portions 63d are not limited by the above description.

Since the third insulating pattern portions 73 are provided on the third conductor pattern portions 63d at sides facing the second principal surface 22, the third conductor pattern portions 63d bulge toward the first principal surface 21 (radiation surface).

The third conductor pattern portions 63d are shaped as illustrated in FIG. 10. Thus, the third conductor pattern portions 63d have a convex shape. In other words, a central portion of each third conductor pattern portion 63d protrudes farther toward the first magnetic portion 51 than do both end portions of the third conductor pattern portion 63d. In other words, a centroid of each third conductor pattern portion 63d is shifted toward the first magnetic portion 51 in the lamination direction D1. More specifically, the centroid of each third conductor pattern portion 63d is closer to the first principal surface 21 than is the centroid of a flat third conductor pattern portion in the lamination direction D1. Each third conductor pattern portion 63d does not necessarily have a sharply protruding shape, and may have a gently protruding shape.

The multilayer body including the first non-magnetic portion 41, the first magnetic portion 51, and the second magnetic portion 52 may be sintered while being pressed in the lamination direction D1 after the third insulating pattern portions 73 are formed on the third conductor pattern portions 63d. In this case, as a result of being pressed in the lamination direction D1, each third conductor pattern portion 63d is shaped such that the central portion thereof protrudes farther toward the first principal surface 21 than do both end portions thereof. The second conductor pattern portion 62, which is not provided with an insulating pattern portion similar to the second insulating pattern portion 72, is not shaped similarly to the third conductor pattern portions 63d, and has a flat or substantially flat shape.

When the third insulating pattern portions 73 are provided on the corresponding third conductor pattern portions 63d as in the fifth preferred embodiment, the degree to which the first conductor pattern portion 61 bulges can be increased because the thicknesses of the third insulating pattern portions 73 are accumulated. As the degree to which the first conductor pattern portion 61 bulges increases, the direction of the magnetic flux ϕ1 (see FIG. 4A) in the first magnetic portion 51 can be brought closer to the lamination direction D1.

The third insulating pattern portions 73 are voids. In other words, the third insulating pattern portions 73 are void pattern portions having a void pattern.

Since the third insulating pattern portions 73 are voids, the relative dielectric constant of each third insulating pattern portion 73 is less than that of the first non-magnetic portion 41. Therefore, the stray capacitance between two third conductor pattern portions 63d that are adjacent to each other in the lamination direction D1 and the stray capacitance between the third insulating pattern portion 73 that is closest to the second conductor pattern portion 62 and the second conductor pattern portion 62 is less than that when the third insulating pattern portions 73 are not provided. As a result, the Q factor of the antenna element 1d can be increased.

In addition, since the third insulating pattern portions 73 are voids, stress generated in the first non-magnetic portion 41 due to the difference in coefficient of linear expansion between the first non-magnetic portion 41 and the first magnetic portion 51 can be reduced. In addition, stress generated in the first non-magnetic portion 41 due to the difference in coefficient of linear expansion between the first non-magnetic portion 41 and the second magnetic portion 52 can also be reduced. Accordingly, formation of cracks in a direction orthogonal or substantially orthogonal to the lamination direction D1 (for example, direction D2) can be reduced.

A non-limiting example of a method for manufacturing the antenna element 1d according to the fifth preferred embodiment will now be described with reference to FIGS. 11 and 12. The antenna element 1d according to the fifth preferred embodiment is manufactured by first to eighth steps. Base material layers illustrated in FIGS. 11 and 12 are the non-magnetic layers S1, S3 to S5, S7 to S9, and S11 and the magnetic layers S2, S6a, and S10. The one-dot chain lines in FIGS. 11 and 12 show major connections provided by interlayer connection conductors. The magnetic layer S6a illustrated in FIG. 11 and the non-magnetic layer S7 illustrated in FIG. 12 are electrically connected to each other by interlayer connection conductors.

In the first step, the non-magnetic layers S1, S3 to S5, S7 to S9, and S11 and the magnetic layers S2, S6a, and S10 are prepared. The non-magnetic layers S1, S3 to S5, S7 to S9, and S11 are each preferably a sintered body of, for example, a non-magnetic ferrite of a low temperature co-fired ceramic. The magnetic layers S2, S6a, and S10 are each preferably a sintered body of, for example, a magnetic ferrite of a low temperature co-fired ceramic.

In the second step, the plurality of terminal electrodes T1 to T6 are formed on the back surface of the non-magnetic layer S1. The terminal electrodes T1 to T6 are each a rectangular or substantially rectangular conductor pattern. The plurality of conductors 23 to 28 are formed on the back surface of the magnetic layer S2. The conductors 23 to 28 are each a conductor pattern having a shape similar to the shape of the terminal electrodes T1 to T6 (rectangular or substantially rectangular shape). The terminal electrodes T1 to T6 and the conductors 23 to 28 are preferably, for example, conductor patterns including Ag as a main component.

Frame-shaped insulating films (not shown) that cover outer edge portions of the terminal electrodes T1 to T6 are formed on the back surface of the non-magnetic layer S1. More specifically, after the terminal electrodes T1 to T6 are formed on the back surface of the non-magnetic layer S1, paste of non-magnetic material (non-magnetic ferrite) is applied to cover the outer edge portions of the terminal electrodes T1 to T6 in the shape of frames by printing, and is fired to form the insulating films.

In the third step, the second conductor pattern portion 62 is formed on the back surface of the non-magnetic layer S3, the third conductor pattern portions 63d are formed on the back surfaces of the non-magnetic layers S4, S5, and S7 to S9 and the magnetic layer S6a, and the first conductor pattern portion 61 is formed on the back surface of the magnetic layer S10. More specifically, the second conductor pattern portion 62, which extends about one turn, for example, is formed on the back surface of the non-magnetic layer S3. One of the third conductor pattern portions 63d, which extends about one turn, for example, is formed on the back surface of the non-magnetic layer S4. Another one of the third conductor pattern portions 63d, which extends about one turn, for example, is formed on the back surface of the non-magnetic layer S5. Another one of the third conductor pattern portions 63d, which extends about one turn, for example, is formed on the back surface of the magnetic layer S6a. Another one of the third conductor pattern portions 63d, which extends about one turn, for example, is formed on the back surface of the non-magnetic layer S7. Another one of the third conductor pattern portions 63d, which extends about one turn, for example, is formed on the back surface of the non-magnetic layer S8. Another one of the third conductor pattern portions 63d, which extends about one turn, for example, is formed on the back surface of the non-magnetic layer S9. The first conductor pattern portion 61, which extends about one turn, for example, is formed on the back surface of the magnetic layer S10.

In the fourth step, the auxiliary film 701, which extends about one turn, for example, is provided on the first conductor pattern portion 61 on the back surface of the magnetic layer S10. In addition, the auxiliary films 703, which each extend about one turn, for example, are provided on the third conductor pattern portions 63d on the back surfaces of the non-magnetic layers S4, S5, and S7 to S9 and the magnetic layer S6a.

In the fifth step, the position mark 705 (mark that facilitates positioning during manufacture) is formed on the front surface of the non-magnetic layer S11. The conductor 704 is formed on the back surface of the non-magnetic layer S11. The position mark 705 is a rectangular or substantially rectangular conductor pattern. The conductor 704 is a conductor pattern having a shape similar to the shape of the position mark 705 (rectangular or substantially rectangular shape). The position mark 705 and the conductor 704 are preferably, for example, conductor patterns including Ag as a main component.

In the sixth step, the non-magnetic layer S1, the magnetic layer S2, the non-magnetic layer S3, the non-magnetic layer S4, the non-magnetic layer S5, the magnetic layer S6a, the non-magnetic layer S7, the non-magnetic layer S8, the non-magnetic layer S9, the magnetic layer S10, and the non-magnetic layer S11 are stacked in that order. The non-magnetic layer S1 is the bottom layer of the multilayer body, and the non-magnetic layer S11 is the top layer of the multilayer body. More specifically, in the sixth step, the non-magnetic layer S9 is stacked on the magnetic layer S10 to cover the back surface on which the first conductor pattern portion 61 and the auxiliary film 701 are provided.

In the seventh step, the magnetic layers and the non-magnetic layers in a stacked state are pressed in the lamination direction D1, so that a portion of the first conductor pattern portion 61 on which the auxiliary film 701 is provided is positioned farther toward the magnetic layer S10 than is the remaining portion of the first conductor pattern portion 61.

In the eighth step, the multilayer body is sintered to form the first insulating pattern portion 71 having the line width δ21 (see FIG. 1B) less than the line width δ11 (see FIG. 1B) of the first conductor pattern portion 61. At this time, the auxiliary film 701 provided on the first conductor pattern portion 61 on the back surface of the magnetic layer S10 is burned so that the first insulating pattern portion 71, which is a void, is formed at the position where the auxiliary film 701 has been present.

As described above, according to the antenna element 1d of the fifth preferred embodiment, the third magnetic portion 53 is provided to divide the first non-magnetic portion 41 into at least two sections. Thus, the first non-magnetic portion 41 can be divided into two sections which each have a small thickness, so that tensile stress applied to the magnetic portions, such as the first magnetic portion 51, can be reduced. As a result, formation of cracks in the lamination direction D1 in the magnetic portions can be reduced.

According to the antenna element 1d of the fifth preferred embodiment, the second non-magnetic portion 42, which has a strength higher than that of the first magnetic portion 51, is disposed closer to the first principal surface 21 than is the first magnetic portion 51 (provided on the outer side of the first magnetic portion 51). In addition, the third non-magnetic portion 43, which has a strength higher than that of the second magnetic portion 52, is disposed closer to the second principal surface 22 than is the second magnetic portion 52 (provided on the outer side of the second magnetic portion 52). Accordingly, the strength of the antenna element 1d can be increased.

According to a modification of the fifth preferred embodiment, the multilayer body 2d may include a plurality of third magnetic portions 53. In this modification, the third magnetic portions 53 are provided to divide the first non-magnetic portion 41 into two or more sections.

According to a modification of the fifth preferred embodiment, the coil conductor 3d may include only one third conductor pattern portion 63d. Thus, the coil conductor 3d is only required to include at least one third conductor pattern portion 63d.

In addition, according to a modification of the fifth preferred embodiment, the coil conductor 3d may include only one third insulating pattern portion 73. Thus, the coil conductor 3d is only required to include at least one third insulating pattern portion 73.

According to a modification of the fifth preferred embodiment, the third insulating pattern portions 73 may each be formed of insulating paste instead of being a void, the insulating paste having a relative dielectric constant less than that of the first non-magnetic portion 41. In this modification, the third insulating pattern portions 73 are formed by placing the insulating paste on each of the third conductor pattern portions 63d at the side facing the second principal surface 22.

Each of the antenna elements according to the above-described modifications also has advantageous effects similar to those of the antenna element 1d according to the fifth preferred embodiment.

The above-described preferred embodiments and modifications are only some of various preferred embodiments and modifications of the present invention. Various changes are possible in the preferred embodiments and modifications in accordance with, for example, the design as long as the advantageous effects of the present invention can be achieved.

For example, in the above-described preferred embodiments, the first insulating pattern portion 71, the second insulating pattern portion 72, and the third insulating pattern portions 73 are described as examples of the insulating portions. However, the insulating portions are not necessarily patterns that extend along the entire or substantially the entire lengths of the coil conductors. The insulating portions may instead be provided on only portions along the lengths of the coil conductors, or may be discontinuous patterns.

The above-described preferred embodiments and modifications disclose the following aspects.

An antenna element (1; 1a; 1b; 1c; 1d) according to a preferred embodiment of the present invention includes a multilayer body (2; 2c; 2d) and a coil conductor (3; 3a; 3b; 3d). The multilayer body (2; 2c; 2d) includes a first non-magnetic portion (41) and a first magnetic portion (51). The first magnetic portion (51) is laminated on the first non-magnetic portion (41). The coil conductor (3; 3a; 3b; 3d) is provided in the multilayer body (2; 2c; 2d). The coil conductor (3; 3a; 3b; 3d) has a winding axis that is parallel or substantially parallel to a lamination direction (D1) of the multilayer body (2; 2c; 2d). The multilayer body (2; 2c; 2d) includes a first principal surface (21) and a second principal surface (22). The second principal surface (22) is opposite to the first principal surface (21) in the lamination direction (D1), and defines and functions as a mounting surface. The first magnetic portion (51) is closer to the first principal surface (21) than is the first non-magnetic portion (41) in the lamination direction (D1). The coil conductor (3; 3a; 3b; 3d) includes a first conductor pattern portion (61) and a first insulating portion (first insulating pattern portion 71). The first conductor pattern portion (61) is disposed between the first non-magnetic portion (41) and the first magnetic portion (51) in the lamination direction (D1). The first insulating portion is provided on the first conductor pattern portion (61) at a side facing the second principal surface (22), and has a width (line width δ21) less than a line width (δ11) of the first conductor pattern portion (61). The first insulating portion overlaps the first conductor pattern portion (61) in plan view as viewed in the lamination direction (D1).

According to an antenna element (1; 1a; 1b; 1c; 1d) of a preferred embodiment of the present invention, the magnetic loss is less than that when the coil conductor (3; 3a; 3b; 3d) is covered with a magnetic portion.

In addition, according to an antenna element (1; 1a; 1b; 1c; 1d) of a preferred embodiment of the present invention, the first conductor pattern portion (61) can be shaped to bulge toward the first principal surface (21), so that the direction of the magnetic flux (ϕ1) can be brought closer to the lamination direction (D1) than to the direction (D2) orthogonal or substantially orthogonal to the lamination direction (D1). In particular, the side surface of the first conductor pattern portion (61) facing the first principal surface (21) protrudes by a greater amount than does the side surface of the first conductor pattern portion (61) facing the second principal surface (22). Therefore, the direction of the magnetic flux (ϕ1) can be easily brought closer to the lamination direction (D1). As a result, the communication performance of the antenna element (1; 1a; 1b; 1c; 1d) can be improved.

Thus, according to an antenna element (1; 1a; 1b; 1c; 1d) of a preferred embodiment of the present invention, the magnetic loss can be reduced and the communication performance of the antenna element (1; 1a; 1b; 1c; 1d) can be improved.

According to an antenna element (1; 1a; 1b; 1c; 1d) of a preferred embodiment of the present invention, the first insulating portion (first insulating pattern portion 71) is a void.

According to an antenna element (1; 1a; 1b; 1c; 1d) of a preferred embodiment of the present invention, when the first conductor pattern portion (61) has another conductor in a region surrounding the first conductor pattern portion (61), a void is provided between the first conductor pattern portion (61) and the other conductor. Therefore, the stray capacitance generated between the first conductor pattern portion (61) and the conductor can be reduced.

According to an antenna element (1a) of a preferred embodiment of the present invention, the multilayer body (2) further includes a second magnetic portion (52). The second magnetic portion (52) is closer to the second principal surface (22) than is the first non-magnetic portion (41). The coil conductor (3a) further includes a second conductor pattern portion (62a) and a second insulating portion (second insulating pattern portion 72). The second conductor pattern portion (62a) is disposed between the first non-magnetic portion (41) and the second magnetic portion (52) in the lamination direction (D1). The second insulating portion is provided on the second conductor pattern portion (62a) at a side facing the first principal surface (21), and has a width (line width δ22) less than a line width (δ12) of the second conductor pattern portion (62a). The second insulating portion overlaps the second conductor pattern portion (62a) in plan view as viewed in the lamination direction (D1).

According to an antenna element (1a) of a preferred embodiment of the present invention, the second conductor pattern portion (62a) can be shaped to bulge toward the second principal surface (22), so that the direction of the magnetic flux (ϕ2) can be brought closer to the lamination direction (D1) than to the direction (D2) orthogonal or substantially orthogonal to the lamination direction (D1). As a result, the communication performance of the antenna element (1a) can be further improved.

According to an antenna element (1b; 1d) of a preferred embodiment of the present invention, the coil conductor (3b; 3d) further includes at least one third conductor pattern portion (63b; 63d) and at least one third insulating portion (third insulating pattern portion 73). The third conductor pattern portion (63b; 63d) is disposed in the first non-magnetic portion (41). The third insulating portion is provided on the third conductor pattern portion (63b; 63d) at a side facing the second principal surface (22), and has a width less than a line width of the third conductor pattern portion (63b; 63d). The third insulating portion overlaps the third conductor pattern portion (63b; 63d) in plan view as viewed in the lamination direction (D1).

According to an antenna element (1b; 1d) of a preferred embodiment of the present invention, the thickness of the first insulating portion (first insulating pattern portion 71) and the thickness of the third insulating portion (third insulating pattern portion 73) are accumulated in the lamination direction (D1), so that the degree to which the first conductor pattern portion (61) bulges can be increased. As a result, the direction of the magnetic flux can be brought even closer to the lamination direction (D1).

In addition, according to an antenna element (1b; 1d) of a preferred embodiment of the present invention, when the third insulating portion is a void, the stray capacitance between the second conductor pattern portion (62) and the third conductor pattern portion (63b; 63d) can be reduced. Therefore, the Q factor of the antenna element (1b; 1d) can be increased.

In addition, according to an antenna element (1b; 1d) of a preferred embodiment of the present invention, when the third insulating portion is a void, stress generated in a non-magnetic portion (for example, the first non-magnetic portion (41)) due to the difference in coefficient of linear expansion between the non-magnetic portion and a magnetic portion (for example, the first magnetic portion (51)) can be reduced. Accordingly, formation of cracks in the direction (D2) orthogonal or substantially orthogonal to the lamination direction (D1) can be reduced in regions between the conductor patterns (regions between the first conductor pattern portion (61) and the third conductor pattern portion (63b; 63d) and between the third conductor pattern portions (63b; 63d)).

According to an antenna element (1c; 1d) of a preferred embodiment of the present invention, the multilayer body (2c; 2d) further includes a third magnetic portion (53). The third magnetic portion (53) divides the first non-magnetic portion (41) into at least two sections in the lamination direction (D1).

According to an antenna element (1c; 1d) of a preferred embodiment of the present invention, the first non-magnetic portion (41) can be divided into two sections which each have a small thickness, so that tensile stress applied to a magnetic portion, such as the first magnetic portion (51), can be reduced. As a result, formation of cracks in the lamination direction (D1) in the magnetic portion can be reduced.

According to an antenna element (1d) of a preferred embodiment of the present invention, the multilayer body (2d) further includes a second magnetic portion (52), a second non-magnetic portion (42), and a third non-magnetic portion (43). The second magnetic portion (52) is closer to the second principal surface (22) than is the first non-magnetic portion (41). The second non-magnetic portion (42) is closer to the first principal surface (21) than is the first magnetic portion (51) in the lamination direction (D1). The third non-magnetic portion (43) is closer to the second principal surface (22) than is the second magnetic portion (52) in the lamination direction (D1).

According to an antenna element (1d) of a preferred embodiment of the present invention, the strength of the antenna element (1d) can be increased.

A method for manufacturing an antenna element (1; 1a; 1b; 1c; 1d) according to a preferred embodiment of the present invention includes a step of preparing a non-magnetic layer that forms a non-magnetic portion and a magnetic layer that forms a magnetic portion. The manufacturing method further includes a step of providing a first conductor pattern portion (61) on a principal surface of the magnetic layer. The manufacturing method further includes a step of providing an auxiliary film (701) on the first conductor pattern portion (61), the auxiliary film (701) having a line width less than a line width (δ11) of the first conductor pattern portion (61). The manufacturing method further includes a step of stacking the non-magnetic layer on the magnetic layer so as to cover the principal surface on which the first conductor pattern portion (61) and the auxiliary film (701) are provided. The manufacturing method further includes a step of pressing the magnetic layer and the non-magnetic layer in a stacked state in a lamination direction (D1) so that a portion of the first conductor pattern portion (61) on which the auxiliary film (701) is provided is positioned farther toward the magnetic layer than is a remaining portion of the first conductor pattern portion (61). The manufacturing method further includes a step of sintering a multilayer body to form a first insulating portion (first insulating pattern portion 71) having a width (line width δ21) less than the line width (δ11) of the first conductor pattern portion (61).

According to a method for manufacturing the antenna element (1; 1a; 1b; 1c; 1d) of a preferred embodiment of the present invention, the magnetic loss is less than that when the coil conductor (3; 3a; 3b; 3d) of the antenna element (1; 1a; 1b; 1c; 1d) is covered with a magnetic portion.

In addition, according to a method for manufacturing the antenna element (1; 1a; 1b; 1c; 1d) of a preferred embodiment of the present invention, the first conductor pattern portion (61) of the antenna element (1; 1a; 1b; 1c; 1d) can be shaped to bulge toward the magnetic layer, so that the direction of the magnetic flux (ϕ1) can be brought closer to the lamination direction (D1) than to the direction (D2) orthogonal or substantially orthogonal to the lamination direction (D1). In particular, the side surface of the first conductor pattern portion (61) facing the magnetic layer protrudes by a greater amount than does the side surface of the first conductor pattern portion (61) facing the non-magnetic layer. Therefore, the direction of the magnetic flux (ϕ1) can be easily brought closer to the lamination direction (D1). As a result, the communication performance of the antenna element (1; 1a; 1b; 1c; 1d) can be improved.

Thus, according to a method for manufacturing the antenna element (1; 1a; 1b; 1c; 1d) of a preferred embodiment of the present invention, an antenna element with which the magnetic loss can be reduced and the communication performance of the antenna element (1; 1a; 1b; 1c; 1d) can be improved can be manufactured.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A antenna element comprising:
a multilayer body including a first non-magnetic portion and a first magnetic portion laminated on the first non-magnetic portion; and
a coil conductor provided in the multilayer body and including a winding axis parallel or substantially parallel to a lamination direction of the multilayer body; wherein
the multilayer body includes:
a first principal surface; and
a second principal surface that is opposite to the first principal surface in the lamination direction and that defines a mounting surface;
the first magnetic portion is closer to the first principal surface than is the first non-magnetic portion in the lamination direction;
the coil conductor includes:
a first conductor pattern portion disposed between the first non-magnetic portion and the first magnetic portion in the lamination direction; and
a first insulating portion provided on the first conductor pattern portion at a side facing the second principal surface, the first insulating portion having a width less than a line width of the first conductor pattern portion; and
the first insulating portion overlaps the first conductor pattern portion in plan view as viewed in the lamination direction.

2. The antenna element according to claim 1, wherein the first insulating portion includes a void.

3. The antenna element according to claim 1, wherein
the multilayer body further includes:
a second magnetic portion that is closer to the second principal surface than is the first non-magnetic portion;
the coil conductor further includes:
a second conductor pattern portion disposed between the first non-magnetic portion and the second magnetic portion in the lamination direction; and
a second insulating portion provided on the second conductor pattern portion at a side facing the first principal surface, the second insulating portion having a width less than a line width of the second conductor pattern portion; and
the second insulating portion overlaps the second conductor pattern portion in plan view as viewed in the lamination direction.

4. The antenna element according to claim 1, wherein
the coil conductor further includes:
at least one third conductor pattern portion disposed in the first non-magnetic portion; and
at least one third insulating portion provided on the at least one third conductor pattern portion at a side facing the second principal surface, the at least one third insulating portion having a width less than a line width of the third conductor pattern portion; and
the at least one third insulating portion overlaps the at least one third conductor pattern portion in plan view as viewed in the lamination direction.

5. The antenna element according to claim 1, wherein the multilayer body further includes a third magnetic portion dividing the first non-magnetic portion into at least two sections in the lamination direction.

6. The antenna element according to claim 1, wherein
the multilayer body further includes:
a second magnetic portion that is closer to the second principal surface than is the first non-magnetic portion;
a second non-magnetic portion that is closer to the first principal surface than is the first magnetic portion in the lamination direction; and
a third non-magnetic portion that is closer to the second principal surface than is the second magnetic portion in the lamination direction.

7. The antenna element according to claim 1, wherein the first magnetic portion includes at least one magnetic layer including a magnetic ferrite of a low temperature co-fired ceramic.

8. The antenna element according to claim 3, wherein the second magnetic portion includes at least one magnetic layer including a magnetic ferrite of a low temperature co-fired ceramic.

9. The antenna element according to claim 1, wherein the first conductor pattern portion includes Ag as a main component.

10. The antenna element according to claim 3, wherein the second conductor pattern portion includes Ag as a main component.

11. The antenna element according to claim 4, wherein the at least one third conductor pattern portion includes Ag as a main component.

12. The antenna element according to claim 1, wherein the first conductor pattern portion has a convex shape that bulges toward the first principal surface.

13. The antenna element according to claim 1, wherein a central portion of the first conductor pattern portion protrudes farther toward the first magnetic portion than end portions of the first conductor pattern portion.

14. The antenna element according to claim 3, wherein the second conductor pattern portion has a convex shape that bulges toward the second principal surface.

15. The antenna element according to claim 3, wherein a central portion of the second conductor pattern portion protrudes farther toward the second magnetic portion than end portions of the second conductor pattern portion.

16. The antenna element according to claim 4, wherein each of the at least one third conductor pattern portion has a convex shape that bulges toward the first principal surface.

17. The antenna element according to claim 4, wherein a central portion of each of the at least one third conductor pattern portion protrudes farther toward the first magnetic portion than end portions of the at least one third conductor pattern portion.

18. A method for manufacturing an antenna element, the method comprising:
a step of preparing a non-magnetic layer that forms a non-magnetic portion and a magnetic layer that forms a magnetic portion;
a step of providing a first conductor pattern portion on a principal surface of the magnetic layer;
a step of providing an auxiliary film on the first conductor pattern portion, the auxiliary film having a width less than a line width of the first conductor pattern portion;
a step of stacking the non-magnetic layer on the magnetic layer so as to cover the principal surface on which the first conductor pattern portion and the auxiliary film are provided;
a step of pressing the magnetic layer and the non-magnetic layer in a stacked state in a lamination direction so that a portion of the first conductor pattern portion on which the auxiliary film is provided is positioned farther toward the magnetic layer than is a remaining portion of the first conductor pattern portion; and
a step of sintering a multilayer body to form a first insulating portion having a width less than the line width of the first conductor pattern portion.
